(19) United States
(12) Patent Application Publication
(10) Pub. No.: US 2004/0210661 A1
(43) Pub. Date: Oct. 21, 2004

(54) Systems and methods of profiling, matching and optimizing performance of large networks of individuals

(76) Inventor: Mark Gregory Thompson, Dallas, TX (US)

Correspondence Address: JENKENS & GILCHRIST, A Professional Corporation, Suite 3200, 1445 Ross Avenue, Dallas, TX, 75202-2799, US

(21) Appl. No.: 10/757,091

(22) Filed: Jan. 14, 2004

Related U.S. Application Data
(60) Provisional application No. 60/440,186, filed on Jan. 14, 2003.

(51) Int. Cl. G06F 15/16

(52) U.S. Cl. 709/228

(57) ABSTRACT

The invention relates to integrating multiple methods of profiling user attributes and preferences, using expert systems to code attributes of objects, predicting goodness of fit between users and candidates or objects, searching for compatible matches, optimizing searching effectiveness, customizing information and commerce to fit user preferences and attributes, and assisting the users to form and maintain new connections with their matches. More specifically, the inventive methods relate to offering integrative solutions to situations where large networks of people seek to find optimal fits between the mutual preferences and attributes. The invention also relates to systems that leverage user feedback and observations of user behavior to create user-dependent logic. Finally, the methods relate to interventions designed to enhance performance via automated coaching, educational course, targeted reinforcement, and peer support and feedback.

### CROSS REFERENCES TO RELATED APPLICATIONS

This application claims priority to U.S. Provisional Application Serial No. 60/440,186 filed on Jan. 14, 2003 which is fully incorporated by reference herein.

### TECHNICAL FIELD OF THE INVENTION

The invention relates to integrating multiple methods of profiling user attributes and preferences, using expert systems to code attributes of objects, predicting goodness of fit between users and candidates or objects, searching for compatible matches, optimizing searching effectiveness, customizing information and commerce to fit user preferences and attributes, and assisting the users to form and maintain new connections with their matches. More specifically, the inventive methods relate to offering integrative solutions to situations where large networks of people seek to find optimal fits between the mutual preferences and attributes. The methods relate to assessment and searching systems, designed to increase the efficiency of testing, improve accuracy through use of both explicit and implicit evaluation, and optimize the predictive power of limited data through statistical means. These methods are also related to systems that leverage user feedback and observations of user behavior to create user-dependent logic. Finally, the methods relate to interventions designed to enhance performance via automated coaching, educational course, targeted reinforcement, and peer support and feedback.

### BACKGROUND OF THE INVENTION

The methods and systems of the invention address gaps in the breadth, depth, and effectiveness of current searching and matching (search/match) systems involving large networks of people seeking specific objects or connections with others. The deficiencies in the existing art may be summarized as follows:

Currently existing search and match systems are dependent on the quality of two parameters: (1) preference tags, or the listing of a user's (or any searching body's) likes and dislikes (and their relative importance), and (2) attribute tags, or the descriptions of the features or traits of an object, person, or organization being considered. Although advances have been made in the sophistication of logic the can match preferences with attributes, there remains a dearth of informational tags to drive the systems and meet goals. Indeed, most search and matching systems (for seeking web sites, jobs, dates, books, music, movies, travel, etc.) rely on demographic tags for the users and very basic key word tags for the sought objects or people. There is an absence of systems for in-depth coding of topics or objects based on expert systems or human evaluation. In addition, users lack options for conducting in-depth assessments of their preferences and attributes, and at best, rely on only the user's opinion and self-report questionnaires with uncertain validity and reliability.

Given the very limited use of information, currently existing search/match systems lack means of synthesizing multiple measures, methods, and sources of information. Yet, multi-method/multi-measure models are the gold standard for scientific assessment and effective prediction. Science-driven systems also require the use of multiple statistical approaches fitting multiple types of data and the ability to synthesis mixtures of complementing, contradicting, inexact, and missing sources of information.

In currently existing systems, search/match results are viewed as one-time events and offer no context regarding how a search fits within what one can expect should one do numerous searches. In situations, such as online dating, users conduct repeated searches over time until they find a desired relationship, and see a plurality of possible candidates with each search. In these systems, it is usually unclear how one judges the fit quality or ranking of a search result or match. Therefore, a system that models numerous possible searches and identifies specific matches in the top percentile of all possible searches a user is likely to perform, does not currently exist in the art.

Currently existing systems also view the user and the sought candidate or object as static entities. Targeted people or organizations are not framed as participants in the process. In other words, currently existing systems do not engage the target. Yet, target people and organizations are able to offer valuable information on whether the recommended fit was adequate or inadequate as well as a perspective on the preferences and attributes the user brings to the encounter.

Feedback from a user and a targeted match is very valuable if the system can adjust and learn from it. Currently existing systems cannot incorporate and synthesize a plurality of outcome information. A system is needed which can consider the gap between predicted and observed outcomes across numerous dimensions, from numerous sources, and make adjustments to both the user-dependent algorithms (based on the specific user) and user-independent algorithms (which can be generalized to all similar users).

Furthermore, references and attributes are currently viewed as static qualities, when in fact, people and organizations often seek to actively change their wants, desires, features, and characteristics. For example, people are often dissatisfied with their patterns of searching, for jobs or possible dates. Similarly, people actively try to change their physical and personality attributes and skills in order to be more attractive to potential employers or dates. Currently existing search/match system do not educate, coach, or offer intervention for those who wish to make such changes.

The inventive methods and systems presented herein address one or more of the shortcomings in the prior art. For example, forming and maintaining meaningful social and romantic relationships has emerged as one of the major challenges of modern life. However, currently existing systems do not provide optimal solutions to address this challenge. Another area where currently existing systems are inadequate is the job search filed where a job seeker (user) attempts to find a desired job (target). As discussed above, the business models and techniques currently employed by existing search/match systems involving large networks of users who are seeking specific objects, connections or targets have disadvantages, fall short of addressing the users' needs and fail to deliver consistent successful matches.

In summary, there exists a need in the art for an on-line matchmaking system which expands the amount and types of sensory information that is collected from users, utilized in the matching logic routines and presented to potential compatible persons. There also exists a need for greater user control over the matching techniques. In addition, a need exists for integrating solutions to forming and improving relationships.

### SUMMARY OF THE INVENTION

An embodiment of the invention provides an integrated method of profiling, matching, and optimizing performance among large networks of people. Another embodiment of the invention provides an integrated connection system, which facilitates one or more methods of the invention.

In an embodiment of the present invention, an integrated connection system comprises a server having a processor for executing component software applications and for exchanging data related to the software applications with a client over a network medium, plus a human-based client interface. In an aspect of the invention the software application contains logic to assess a variety of user attributes and preferences, and then “tag” users with codes that signify these attributes and preferences, which then creates a unique “thumbprint” that facilitates matching them with desired people, advice, intervention, entertainment, and objects.

An aspect of the invention facilitates multiple means of assessing attributes and preferences directly from the user, indirectly through peer reports, via automated tools, and via integrated expert systems that conduct in-depth coding of objects. In an aspect of the invention, the integrated connection system reaches conclusions by synthesizing multiple sources of information, searching for compatible matches between preferences and matches, guiding users and offering customized information via a personalized computer agent, and delivering skill-building education and training. In an aspect of the invention, the software application contains logic to gather feedback regarding the effectiveness of and user satisfaction with results.

### BRIEF DESCRIPTION OF DRAWINGS

These and further features of the present invention will be apparent with reference to the following description and drawings, wherein:

FIG. 1 is a block diagram of an embodiment of the method and system according to the present invention;

FIG. 2 is a block diagram of an embodiment of integrated connection system according to the present invention;

FIG. 3 is a functional block diagram of an embodiment of an integrated connection system application according to the present invention;

FIG. 4 is a flowchart illustrating an embodiment of a systematic attraction matching (SAM) agent module of an embodiment of the software application;

FIG. 5 is a flowchart illustrating an embodiment of a customize module of an embodiment of the software application;

FIG. 6 is a flowchart illustrating an embodiment of a physical module of an embodiment of the software application;

FIG. 7 is a flowchart illustrating an embodiment of a personality module of an embodiment of the software application;

FIG. 8 is a flowchart illustrating an embodiment of a match engine module and an explore module of an embodiment of the software application;

FIG. 9 is a flowchart illustrating an embodiment of a preference module and a calculation module of an embodiment of the software application;

FIG. 10 is a flowchart illustrating an embodiment of a search module of an embodiment of the software application; and

FIG. 11 is a flowchart illustrating an embodiment of a coding module of an embodiment of the software application.

### DESCRIPTION OF EXEMPLARY EMBODIMENTS

An embodiment of the invention provides a method of profiling, matching and optimizing performance of large networks of individuals, comprising obtaining information of a user's preferences relative to a target, synthesizing the information into conclusions, estimating the fit between the user's preferences and a potential target's attributes, predicting an outcome of an encounter between a user and a target, observing the outcome between the user and the target and obtaining feedback from the user and the target after the occurrence of the encounter.

In the description which follows, identical components have been given the same reference numerals, regardless of whether they are shown in different embodiments of the present invention. In order to illustrate the invention in a clear and concise manner, the drawings may not necessarily be to scale and certain features may be shown in somewhat schematic form.

As used herein, the terms “user” and “seeker” are intended to be synonymous with one another. As used herein, the terms “object”, “target” and candidate are intended to be synonyms.

A further embodiment of the invention provides a method of matching large networks of individuals with one or more targets, comprising matching a user with a first set of potentially compatible targets based on mutually corresponding preferences, the first set being generated with a set of user-independent search criteria, modifying the user-independent search criteria with feedback from the user and criteria established by the user, and generating subsequent sets of potentially compatible targets based on the modified criteria.

An embodiment of the present invention is described herein in the context of matching romantic partners, however, it should be understood that profiling, matching, and optimizing connections among a variety of people, in different settings, with different connectivity goals can be accomplished using the techniques presented. These alternative connectivity contexts are intended to fall within the scope of the present invention. Example alternative connections include, but are not limited to, other social or recreational links (e.g., traveling companions, golfing or tennis partners, movie goers), human resources (e.g., job hiring, assignment of employees to new teams or workgroups, enhancing team performance), professional or instrumental affiliations (e.g., roommates, office space partners), any decision to assign an individual to one of several options based on assessment (e.g., matching people to doctors, vacation types, buying cars), any attempt to capture the priority and interaction among a variety of preferences (e.g., assessment of fashion tastes), and the like.

An embodiment of the invention provides a system for profiling, matching and optimizing performance of large networks of individuals, comprising a server having a processor for executing a software application and for exchanging data related to the software application with a user over a network medium, wherein the software application contains logic to assess the preferences of the user along explicit and implicit dimensions and to match the user with potentially compatible targets based on the user's preferences.

The integrated connection system is designed for situations where there are multiple sources of information that compliment, contradict, or may be absent, and must be synthesized in order to estimate preferences or attributes (e.g., need for and qualities of health care plans). Similarly, the system offers innovative means to integrate expert systems in situations where human evaluation and judgment is necessary to estimate an object's attributes (e.g., lab results, job resumes).

The system is designed to optimize solutions in contexts where the candidates or search targets are not inanimate objects, but are active participants in the process and thus can offer feedback on a users' preferences and attributes and the quality of the predicted fit based on their interaction (e.g., blind dates, hiring employers after a job interview). Similarly, the system can gather unique perspectives on a user's preferences and attributes in situations where the user may not be aware of or cannot express their true qualities or desires, but their peers may contribute useful insights (e.g., co-workers insight into a user's career competencies, insight of friends into movies a user might enjoy). In other words, the system offers advantages in situations where a user wishes to enhance their control over searching parameters, to moderate risks, and actively manage choices that are made when exploring or pursuing candidates or objects.

The system advances searching usefulness by placing the goodness-of-fit estimation within the context of all the fits they are likely to encounter, and thus know whether a particular candidate (e.g., job posting, potential date, vacation package) is in the top 5% or 25% of the fits one will likely encounter in all future searches, given one's particular configuration of preferences and the attributes available in the search pool.

The systems and methods of the invention compliment existing search/match systems in contexts where the user may wish to learn more about and understand their preferences or attributes (via reports, peer feedback, and coaching) or intervene to change their preferences or attributes in order to reach their goals more effectively or better align expectations with actual opportunity (e.g., job searchers, financial planners, shoppers).

An embodiment of the invention provides a method for matching a user to a target, said method comprising the steps of accessing a guide that serves as an agent for facilitating the search and match process and customizing related information, allowing a user to personalize the guide's personality, image, representation, voice and other features, performing tests that directly assess the user's preferences and attributes or the object's attributes via self-report clues and counter clues, performing tests that indirectly or obliquely assess the user's or the object's preferences and attributes via implicit methods, obtaining feedback from a target group regarding the user's preferences and attributes or the object's attributes, tagging the attributes of a user or an object via a semi-automated system involving human expert judgment, reporting the presented conclusions on the preferences and attributes of the user and the object in order to promote education and gain further feedback, aggregating multiples clues and synthesizing the clues, while estimating the parameters and confidence levels in light of missing, inexact and contradictory information, customizing the presentation of information, education and advertising and facilitating commerce based on a user's or object's preferences and attributes, estimating the fit quality between the user's preferences and attributes and the preferences and attributes of a pool of potential candidates and objects, providing the user control over the domain to be searched and the level of tolerance for false positives and false negatives, clustering heterogeneous groups of users and objects into homogeneous subgroups based on similarities in preferences and attributes, classifying the object on the basis of the user's satisfaction with the object, searching and ranking a pool of objects based on the estimated fit quality with the user's preferences and attributes, predicting an outcome following one or more encounters between the user and the object, optimizing the quality of the search and match process based on adjustment to the search and match parameters to narrow the gap between predicted and observed behavior, observing the user's behavior to assess the gap between predicted user and observed user actions and reactions, obtaining feedback from the user and the object following at least one encounter between the user and the object, offering advice to the user that is tailored to the user's assessed goals and readiness for change, preparing the information between the user and the object prior to any encounter between the user and the candidate, preparing a user for an encounter with a target by sharing information on the target regarding areas of mutual compatibility while simultaneously priming expectations, trust and familiarity through the implicit use of custom images and words, synthesizing and presenting feedback received from potential targets to the user in a manner that fosters readiness for change, providing intervention to facilitate desired changes in the preferences and attributes of the user or the object, and testing the impact and effectiveness of words and images through an automated system that randomly pulls and systematically evaluates the stimuli from a large pool of media.

A further embodiment of the invention provides a system for matching a user to a target comprising a server having a processor for executing a software application, wherein the user is guided by a customized and personalized agent in the execution of the software application in the areas of data collection, data presentation, or self-improvement.

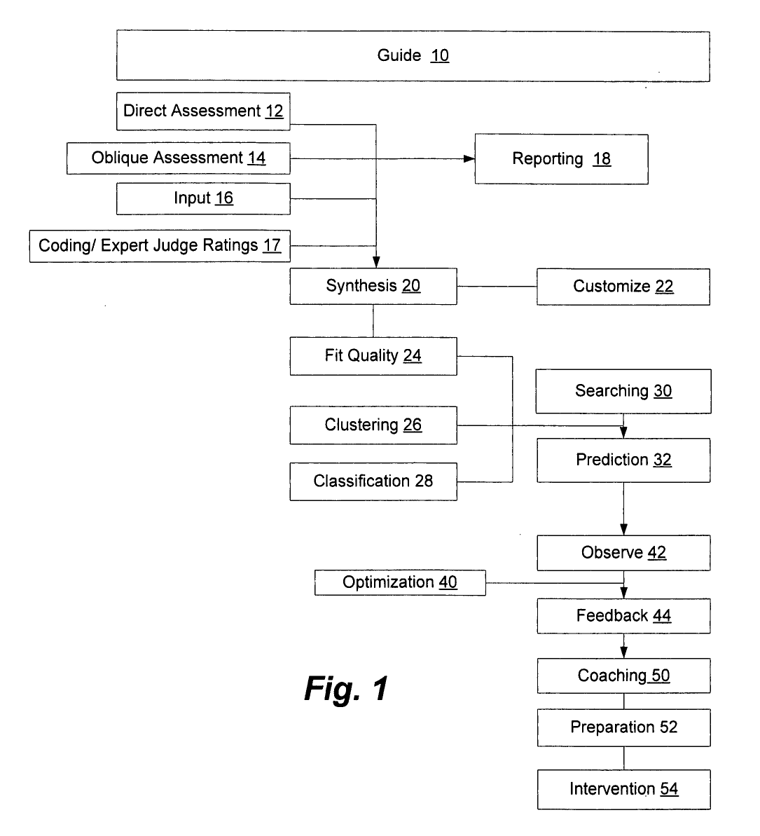

FIG. 1 represents a block diagram which provides a description of a method of the invention and the system associated therewith. A guide 10 is a customized agent that guides, informs and facilitates use of the methods and systems of the invention. A direct assessment module 12 conducts tests that directly assess a user's preferences and attributes or an object's attributes via self-report clues and counter clues. An oblique assessment module 14 conducts tests that indirectly assess preferences and attributes via implicit methods. An input module 16 obtains feedback from a target group regarding a user's preferences and attributes or an object's attributes. A coding module 17 tags the attributes of a user or an object via a semi-automated system that leverages expert judges who conduct subjective ratings as well as provides specific coding that cannot be accomplished via automated means. A reporting module 18 synthesizes and presents conclusions on a user's and/or object's preferences and attributes for the purpose of education and gaining further feedback. A synthesis module 20 aggregates multiple clues and synthesizes the clues by taking into account missing, inexact and contradictory information. A customize module 22 customizes the presentation of information, education and advertising, and facilitates commerce based on a user's or object's preferences and attributes. A fit quality module 24 estimates the fit between a user's preferences and attributes and the preferences and attributes of a pool of potential candidates or objects. A clustering module 26 divides a heterogeneous group of users, candidates or objects into homogeneous subgroups based on similarities in preferences or attributes. A classification module 28 assigns an object or candidate a category or recommendation which reflects the likelihood of a user's satisfaction with the object or candidate. A search/explore module 30 filters and ranks a pool of candidates or objects based on a estimated fit with a user's preferences and attributes. A prediction module 32 predicts the outcome and reactions following encounters between a user and candidate or object based on fit estimates. An optimization module 40 iteratively improves the quality of searches and recommendations based on adjustments to parameters in order to minimize the gap between predictions and observed reactions or feedback identified outcomes. An observe module 42 observes user behavior to assess the gap between predicted user and observed user actions and reactions. A feedback module 44 obtains feedback from a user and targeted candidates or objects following encounters concerning the qualities of the parties or objects and the outcome and satisfaction with the interaction. A coaching module 50 offers advice and motivational messages tailored to a user's current goals and activities. A preparation module 50 customizes information about a user and candidate or object prior to any interaction between the user and candidate or object in order to present the information in a manner that optimizes the liking familiarity and trust between the user and candidate or object. An intervention module 54 offers intervention messages and programs, which facilitate desired changes in the beliefs, preferences, behavior and attributes of a user, candidate or object.

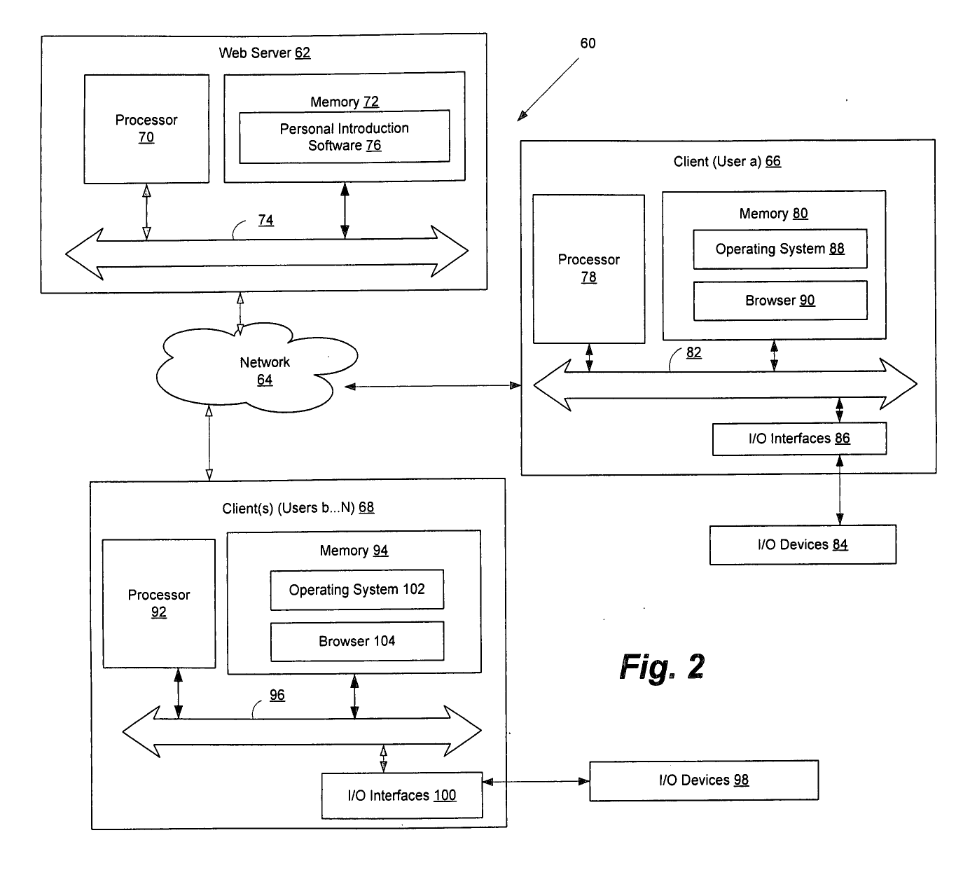

Referring now to FIG. 2, a block diagram of an integrated connection system 60 is illustrated. Briefly, the integrated connection system 60 is a computer network having integrated connection system routines for executing the component processes. The integrated connection in its most basic form, facilitates the formation and maintenance of relationships, partnerships, or affiliations by collecting data about users, matching users with compatible targets and providing performance enhancement features to the users with the ultimate goal of building lasting relationships. The data collected includes an elaborate set of sensory and personality information. The data is used, in combination with control parameters selected by the user, to match the user with a compatible target candidate or object. Selected portions of the information may also be presented to potential compatible candidates or objects. The integrated connection system routine makes extensive use of artificial intelligence (AI) or automated learning programming techniques.

The system 60 includes a series of networked computers. More specifically, a web server 62 is operably coupled to exchange data over a network 64 with a plurality of clients, including a client for a first user, or client 66, and client terminals for additional users or client(s) 68. The network 64 can be, for example, the Internet, a wide area network (WAN), local area network (LAN), or other suitable network. The web server 62 and clients 66, 68 are coupled to the network 64 to facilitate data communication to and from the network 64 in any one of a number of ways that are generally known by those of ordinary skill in the art. The web server 62 and clients 66, 68 may be linked to the network 64 through various devices, such as a network card, a modem, a LAN, a gateway or other suitable arrangement.

The web server 62 comprises a processor 70 for executing instructions, usually in the form of computer code to carry out a specified logic routine, such as an operating system and other software applications. The web server 62 further comprises a memory 72 for storing data, software, logic routine instructions, computer programs, files, operating system instructions and the like. The memory 72 may include both volatile components (components that do not retain data values upon loss of power) and nonvolatile components (components that retain data upon loss of power). Therefore, the memory 72 may comprise random access memory (RAM), read-only memory (ROM), hard disks, floppy disks, compact disks (CDs) or other magnetic and optical media accessed by an appropriate drive device.

The processor 70 and the memory 72 are coupled via a local interface 74, such as a bus. Also coupled to the local interface are input/output (I/O) interfaces (not shown) for coupling the web server 62 to devices (not shown) such as a display (e.g., a monitor), a keyboard, a touch pad, a mouse, a microphone, a joystick, a modem or other network 64 connection device, a printer, a scanner, a camera, etc.

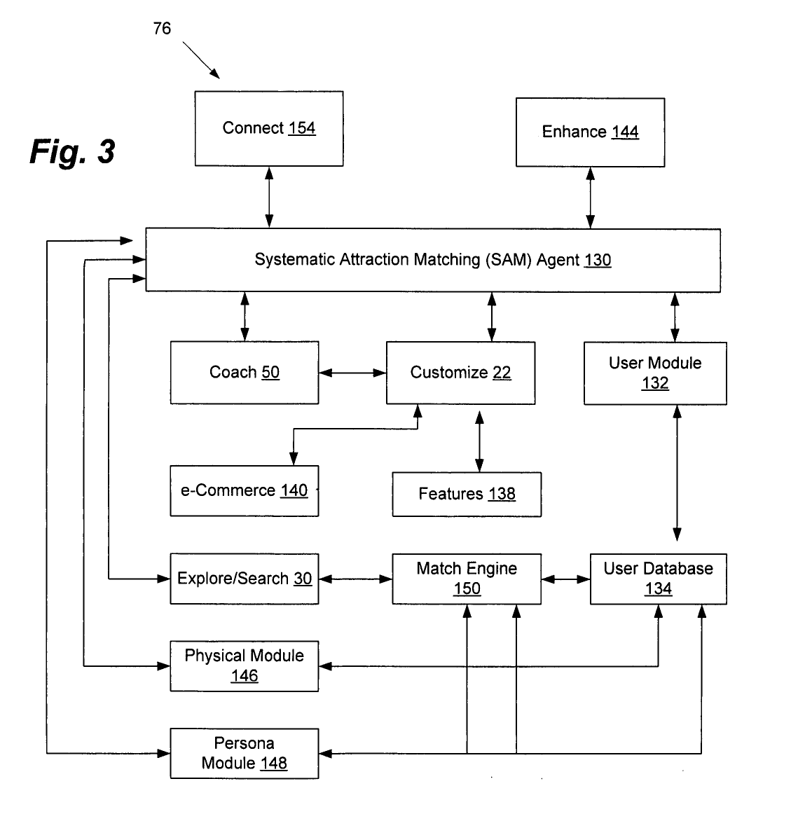

The memory 72 stores a integrated connection system application 76 for execution by the processor 20. In an embodiment of the invention, the software application 26 pertains to a personal introduction application where user seeks a match with a compatible target candidate. The software application 76 is described in greater detail below, but is shown in functional block diagram format in FIG. 3 according to an embodiment of the present invention. Each block represents a module, object, or other grouping or encapsulation of underlying functionality implemented in programming code. However, the same underlying functionality may exist in one or more modules, objects, or other groupings or encapsulations that differ from those illustrated without departing from the present invention. One skilled in the art will appreciate that the underlying functionality can also be embodied in logic hardware or a combination of hardware and software. It is understood that the order of execution of any block in the block diagram of FIG. 2 or the subsequent flow charts may be altered relative to the order shown and described. Blocks shown in succession can be executed concurrently or with partial concurrence. In addition, in the illustrated exemplary programming loops, certain steps need not be completed during each loop. Moreover, the connection software 76 can be embodied in any computer-readable medium for use by or in connection with an instruction execution system such as a computer/processor based system or other system that can obtain logic from the computer-readable medium and execute the instructions contained therein.

The client 66 and additional clients 68 have a similar architecture to the web server 62. Briefly, the client 66 is a computing device having at least one processor 78 operably coupled to a memory 80 via a local interface 82. I/O devices 84 are operably coupled to the processor 78 and memory 80 via the local interface 82 and various I/O interfaces 66. The I/O devices 84 include, but are not limited to, a display (e.g., a monitor), a keyboard, a touch pad, a mouse, a microphone, a joystick, a modem or other network 64 connection device, a printer, a scanner and a camera. The memory 80 stores an operating system 38 for execution by the processor 78. In addition, the memory 80 stores a browser 90 for accessing information over the network 64. The browser 90 can be, for example, an Internet or world-wide-web browser such as INTERNET EXPLORER™ or NETSCAPE NAVIGATOR™ which exchanges (sends and receives) data with the web server 62 over the network 64. More specifically, the browser 90 uses a protocol, such as hypertext transfer protocol (HTTP), to carry requests to the web server 62 and to transport pages in a specified format, such as hypertext markup language (HTML), to the client 66.

Similar to the client 66, the clients 68 each have at least one processor 92 operably coupled to a memory 94 via a local interface 96. I/O devices 98 are operably coupled to the processor 92 and memory 94 via the local interface 96 and various I/O interfaces 100. The I/O devices 98 include, but are not limited to, a display (e.g., a monitor), a keyboard, a touch pad, a mouse, a microphone, a joystick, a modem or other network 64 connection device, a printer, a scanner, a camera, etc. The memory 94 stores an operating system 102 for execution by the processor 92. In addition, the memory 94 stores a browser 104 for exchanging and accessing information over the network 64.

Additional explanation of some of the terms used herein will assist the understanding of the present invention. Various forms of terms “attract”, “attracted to” or “attraction,” as used herein, are intended to include that which draws someone's attention either on a conscious or incognizant level and specifically relates to an individual's preferences regarding both physical attributes and personality attributes. It is noted that physical attributes primarily focuses on visual appearance, but is not limited thereto. How a person audibly sounds to another, smells to another and feels to the touch of another (tactile perception) are also important physical attraction indicators.

The term “assessment” includes a set of conclusions in the form of a user profile derived from tests taken by a user and/or by observing the behavior of the user. An example assessment includes determining what type of persons the user is physically attracted to. The assessments are continually updated as additional data is collected. The term “implicit assessment” is an assessment of the user's unstated, implicit, incognizant or subconscious preferences to which the user may be unaware.

The term “intervention” is used to include programming which directs the user to certain self-enhancement features, programs, pieces of information and the like. The ultimate goal of the intervention conducted by the present invention involves creating change in the users to overcome intrapersonal (perhaps psychological) difficulties and improve their interpersonal functioning. Intervention also includes making that which a user is unaware about themselves more consciously aware.

The software application 76 illustrated in FIG. 3 has a set of modules for carrying out the various features and operations of the software application 76. An introduction to each module will be briefly described, followed by a more detailed description of the software application's operation and how the modules interact with one another. It is noted that two or more modules may be combined or individual modules may be broken up into multiple modules.

The modules include a systematic attraction matching (SAM) agent 130, also referred to as a user agent. The SAM agent 130 serves as each user's logical interface to the remaining modules of the software application 76. The SAM agent 130 is driven by AI logic principles and adapts to become, in practical terms, a unique host and guide for each user as the user interfaces with the data collection, data presentation, interpersonal introduction and self-improvement services provided by the software application 76. Therefore, the SAM agent 130 assists the user in all aspects of the user's interaction with the software application 76. The SAM agent also acts as the user's intermediary with other users. The SAM agent is also programmed to act as an infomediary to the user. More specifically, the SAM agent 76 is capable of filtering and deciding what information, self-enhancement lessons, news items and articles, and commercial items to present to the user.

While the SAM agent 130 underlies almost all aspects of the software application 76, the user's direct graphical user interface with the web server 62 (via the user's own computer or client 66 and network 64) is a user module 132. The user module 132 generates the interactive screens, or web pages, presented to the user using standard protocols and instructions, such as HTTP and HTML, which send and receive the information and data described herein between the client 66 and web server 62. The actual content of the web pages is generated by the SAM agent 130, along with many of the other modules of the software application 76 described in more detail below. The user module 132 gives the user an interface, in graphical user interface (GUI) format, to conduct assessments or review the results of assessments; establish search criteria used by software application 76 matching algorithms and analyze potential matches identified by the matching algorithms; conduct ongoing correspondence with other users; personalize the screens displayed to the user and any items the user selects to display to other users (also referred to as swap items), including photographs, video and audio clips, drawings, written descriptions, favorite cartoons, etc; and establish links to other web sites, on-line events, articles, featured information and the like.

The software application 76 has a user database 134 for each user. The user database 134 stores all information collected about the user, for example, user profiles, the results of assessments, photographs of the user and the like. In addition, the user database 134 stores information used by the other modules of the software application 76, including, but not limited to, the retained knowledge, cues, and other evolved aspects of the user's profile used to construct a personalized SAM agent 130 and user module 132 or each user.

The SAM agent 130 is in continual interaction with a customize module 22. The customize module 22 collects information, either explicitly received from the user or observed by monitoring user behavior, needed to construct a user profile for use in customizing features of the SAM agent 130 and the user module 132. The customize module 22 assesses the information collected and manages features of the SAM agent 130 presented to the user, the content and style of the web pages presented to the user, which assessment testing options to present to the user, which connectivity programs and features (see below) to direct the user's attention to, which performance enhancement programs to present to the user, and which advertisements and electronic commerce to present to the user. The customize module 22 underlies almost all operation of the software application 76 and is responsible for certain aspects of the user's implicit assessment and learning as much as possible about the user.

As mentioned, the SAM agent 130 will provide positive intervention to the user by directing each user to learning and entertainment pages, also referred to herein as features, from which the user may benefit. The features can include articles, games, interviews, comic strips, interactive programs and the like. The content of the features have the main focus of promoting the user to engage his or her emotions and to reinforce key messages and lessons that are presented to the user. The content of the features and/or links to a computer application executing the feature for the user are stored in a features module 138. The specific features to present to a user are accessed by the SAM agent 130 via the customize module 22 such that appropriate features are presented to the user. The features module 138 also contains a repository database of swap items that users can select from for sharing with others.

The SAM agent 130 also accesses an electronic commerce (e-commerce) module 140 via the customize module 22. The electronic commerce module contains a repository database of advertisements, sale items, and links electronic commerce web pages which can be presented to the user. The SAM agent 130 and the customize module 22 act as a filter to decide which items of electronic commerce to present to the user. The use of electronic commerce as part of the software application 76 provides an important role in forming relationships between individuals and enhancing the user's well being. The users are presented with and/or linked to products and services which fit their needs as they learn, connect with others, and experiment and explore with the web site generated by the software application 76, either by themselves or with another person met on-line. For example, the presented products and services can provide each user with customized access to books, fashion, travel, health and beauty products, restaurants, support and therapy networks and so forth.

The SAM agent 130 also interacts with a coach module 50. The coach module 50 is an information repository for the SAM agent 130. During the course of a user's interaction with the software application 76, the SAM agent 130 provides customized information, educational material and advice to the user. This information is extracted from the information maintained by the coach module 50. More specifically, the customize module 22 prompts the SAM agent 130 and the coach module 50 to present the user with certain types of information at certain times. The information contained in the coach module 50 can be predetermined audio, video or text messages, or can be information cues which are processed by the SAM agent 130. The cues contain basic information to be conveyed to the user, but are restructured in an appropriate format for the specific user based on the body of knowledge collected about the individual. This aspect of the SAM agent 130 can be implemented with a natural language program, as is known and undergoing improvement in the art. Armed with the SAM agent's 130 knowledge of the user, the natural language program can construct dialog to present to the user that seems natural and fitting for the situation and/or specific user. For example, if the SAM agent 130 and the customize module 22 have determined that the user targeted to receive the information responds to suggestive behavior, the information contained in the information cue will be presented as a suggestion.

As a specific example, if the software application 76 has determined that the user's facial features draw the attraction of other individuals, but those individuals provide feedback that the user has an out-of-fashion hairstyle, the SAM agent 130 will want to bring this to the attention of the user and perhaps make an intervention with the user concerning the user's hairstyle. Armed with this knowledge, the SAM agent 130 will access the coach module 50 for instruction about changing a user's appearance. The coach module may offer canned dialogue for this situation such as a new hairstyle would look better on you. Alternatively, the coach module 50 may store cues for the SAM agent 130 to process and structure for the user using information from the customized module 22. For example, if the user will respond to a suggestion, the SAM agent 130 will take the cue and present the cue to the user as a suggestion, such as I think you will find that if you change your hairstyle more people may find you attractive. However, if it is determined that the user responds to commands better than suggestions, the SAM agent 130 may take the cue and present the information to the user in a more forceful manner such as advise that you change your hairstyle to increase your attractiveness to others. SAM is also a primary vehicle for conveying synthesized feedback from peers, candidates, employers, or other information sources.

As part of the intervention presented to the users, the SAM agent 130 will refer users to enhancement programs stored in an enhancement module 144. The enhancement programs are interactive learning and performance enhancement programs geared to specific topics of interest to the user or subjects which the SAM agent 130 determines may be beneficial to the user, including those intended to enhance the user's well-being and interpersonal skills. The enhancement programs can taken the form of mini-courses (with or without assignments to be completed by the user), simulations, modeling and role-playing programs, and the like. The topics of the enhancement programs typically are directed to social and relationship functioning of the user, but also include overall emotional, spiritual and physical well-being. Each program shares a common template. More specifically, the programs are about seven sessions long and each session ranges from about two to ten minutes. The programs are customized for the user's age, gender, learning style, readiness for change, and other user attributes. The sessions are designed to bring out characteristics in the user, such as personal control, self-efficacy, positive role modeling, interactivity, and engaging emotions. The programs provide for the ability to interact with others pursuing similar goals.

As discussed above, physical attraction plays a fundamental role in the success of a relationship. The software application 76 is provided with a physical attraction module 146 to assess the physical attraction preferences of each user through a series of test procedures to determine what type of people the user is physically attracted to. This assessment is made against a range of attraction preferences from very high attraction to very low attraction. Determining a range of attraction preferences assists in matching users according to various criteria as discussed below in greater detail. The physical attraction module 146 also assesses what types of people may be physically attracted to the user along a similar attraction range. Briefly, this is accomplished by coding the user's appearance parameters and matching the parameters with known information.

The personality and interests of each user also plays an instrumental role in determining which other persons the user may form a meaningful relationship with. Personality and interests are also characteristics which the AI subroutines of the software application 76 modules, such as the SAM agent 130 and customize module 22, use to learn and produce the user profile. Therefore, the software application 76 is has a personality module 148 to gain additional understanding of the user's personality and to assess a user's explicit (i.e., stated, aware) preferences and implicit (i.e., unrecognized or denied) preferences of the personality traits and interests that the user desires from a partner.

Once sufficient information is gathered about the user, a match engine module 150 is employed to search for potential matches among the other users stored in the user database 134. The search criteria stems primarily from the data and preference profiles collected by the physical module 146 and the personality module 148. The match engine module 150 has adjustable parameters so that truly compatible persons are matched. A truly compatible couple who are in fact matched is also referred to as a true positive. The match engine module 150 is programmed to minimize false positives, or those couples who are matched but turn out not to be compatible, and true negatives, or those couples who were not matched and are indeed not compatible. The number of false negative matches, or pairs that are not matched but who would have been compatible, that the match engine module 150 returns can be adjusted dependent on user preferences as discussed in greater detail below. It is noted that if the match engine module 150 targets a higher number of false negatives, there is a greater likelihood that false positive matches and true negative matches may also be generated.

The match engine module 150 receives information from an explore/search module 30 for setting the parameters used during a search for compatible matches. Namely, the explore module 30 assesses the user's openness to or preference against specific physical or personality characteristics. The explore module also weighs the user's relative importance of limiting false positives and false negatives. For example, a divorced parent of two children or a user with little free time may be interested in only true positives. As another example, a younger user, such as a recent college graduate, may be willing to meet more candidates at the risk of being matched with persons that they are not compatible with. The explore module 30 works on both the user's stated preferences and the user's implicit preferences. Should these preferences differ, the explore module 30 will assess which preference to pass to the match engine module 150 to screen in or out potential matches. It is noted that after a set of candidates is determined, the explore module 30 uses feedback received from the user to further narrow, broaden or redefine the parameters passed to the match engine module 150.

Once two users have been matched and decide to learn more about each other and/or communicate with each other, a connectivity module 154 provides the users with a suite of options that allows the users to communicate and share information with each other. The options include an access to each user's swap information, electronic mail, chat circles, message boards, virtual palaces (i.e., role playing websites), shared tours (e.g., visiting an on-line museum or perusing a virtual bookstore together), games, interactive activities and the like. Many of these activities are intended to give a matched pair of users an “on-line date” experience. The connectivity options emphasize sharing of the on-line experience with other users. These shared experiences are not reserved for matched individuals, but also for users who share specific self-enhancement goals and other interests. For example, many of the enhancement programs from the enhance module 144 and the features from the features 138 module are adaptable for use by one or more users through the connect module 154. The software application 76 monitors the user's behavior during these activities to gather additional information about the user to further redefine and construct the user profile.

As mentioned above, artificial intelligence (AI) agents are used extensively by the software application 76. More specifically, many of the modules discussed above have AI agents to carry out specific functions of the modules. These functions differ from module to module. Therefore, an AI agent, as used herein, is broadly defined as an analyzing tool which enables the software application 76 to simulate certain aspects of human intelligence, such as deductive reasoning, pattern recognition, producing creative responses, the ability to learn from prior experiences and the ability to make inferences from incomplete information, such that the software application 76 can carry out the functions described herein. The AI agents also exhibit characteristics of an expert system, or a system that makes decisions or solves problems using knowledge and analytical rules supplied as part of the software application 76. More specifically, the expert system type AI agents use a knowledge base, such as the user profile, and an inference engine to form conclusions. Additional tools can include user interfaces and explanation facilities, which enable the software application 76 to justify or explain its conclusions as well as allowing a software administrator to run checks on the software application 76. Another type of AI agent used by the software application 76 is a neural network. Neural networks are modeled after the neurons, or nerve cells, in a biological nervous system and intended to simulate the way a brain processes information, learns and remembers. Neural networks are designed as an interconnected system of processing elements, each with a limited number of inputs and an output. These processing elements are able to “learn” by receiving weighted inputs that, with adjustment, time and repetition, can be made to produce appropriate outputs.

TABLE 1 illustrates the modules which use AI agents. The first column on the left lists some of the modules described above in connection with FIGS. 2 and 3. The top row lists six main areas in which AI agents are employed in some of the modules. The first area in which AI agents are employed is for problem solving. More specifically, the generation of a hypothesis given certain input data. For example, the SAM agent 130 may use a problem solving AI agent to determine that a particular user is shy and, along with the problem solving AI agent of the customized module 22, will seek solutions to overcome the user's shyness, such as confidence building programs from the enhanced module 144.

The next area where AI agents are employed is pattern recognition such that the various modules of the software application 76 can recognize the preferences, personality attributes, and other behaviors of the user to assist in generating the user profile. AI agents also include learning agents so that the software application 76 continues to gain knowledge from its own experiences. AI agents also are used to facilitate communication with the user and to negotiate with the user about different options and ways to proceed in the user's on-line experience. For example, the software application 76, by way of the SAM agent 130, may make trade-offs with the user when deciding which parameters to pass from the explore module 30 to the match engine 150. Artificial intelligence agents are also used to personalize features of the SAM agent 130 and the enhance module 144 such that the suggestions and learning programs presented to the user are believable and effective. As one skilled in the art will appreciate, additional AI agents can be used by the various modules of the software application 76.

Each cell of the spreadsheet illustrated in Table 1 is populated with one of three variables. The variables include N/A, standing for not applicable, which indicates that the module identified in the left-hand column does not have an AI agent for the area identified in the top row. The next variable is a single asterisk which indicates the presence of an AI agent. The other variable used in TABLE 1 is a double asterisk which indicates the present of an AI agent and a strong dependency of the indicated module on the AI agent in the indicated area.

TABLE 1

| | Problem | Pattern | | | | Personali- |
|---|---|---|---|---|---|---|
| Module | Solving | Recognition | Learning | Communication | Negotiation | zation |
| SAM | ** | * | ** | ** | * | ** |
| Agent 100 | | | | | | |
| Customize | * | ** | ** | n/a | n/a | n/a |
| 106 | | | | | | |
| Enhance | n/a | n/a | * | * | n/a | * |
| 114 | | | | | | |
| Physical | * | ** | * | n/a | n/a | n/a |
| 116 | | | | | | |
| Personality | * | ** | * | n/a | n/a | n/a |
| 118 | | | | | | |
| Explore | * | ** | * | n/a | ** | n/a |
| 122 | | | | | | |
| Connect | n/a | * | * | * | n/a | n/a |
| 124 | | | | | | |

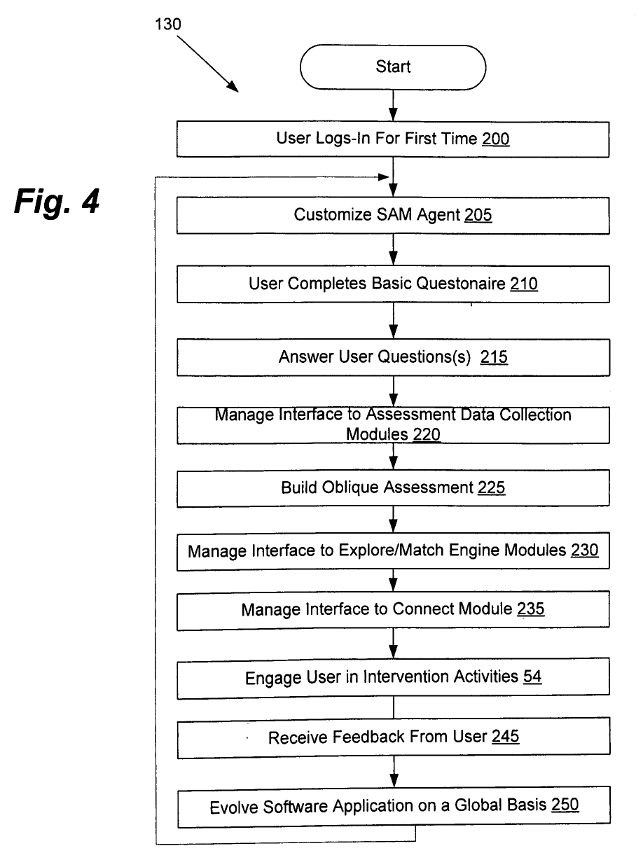

Referring now to FIGS. 4-8 the operation and interaction of the modules illustrated in FIG. 3 will be described in greater detail. It is noted that as the user interacts with the software application 76 there is no one set pattern in which to use all of the features provided by the software application 76. Therefore, the user-interaction with the software application 76 is likened more to a personal journey rather than a discreet step-by-step procedure through a flowchart. The user and the software application 76 can select from multiple paths and modes of operations which greatly depends on the user and his/her pacing, pauses in use of the software application 76, obstacles, challenges, decisions, encounters with others, and other personal factors. This iterative process is partially captured by the flowcharts of FIGS. 4 through 8 but one skilled in the art should appreciate that the flowcharts have overlapping functionality with each other and represent only one embodiment of the invention described herein. Furthermore, the users of the software application 76 are human beings with highly complex nervous systems and emotional responses. In addition, the software application 76 is involved with collecting and using multiple forms of sensory information and involves itself with dynamic interactions among individuals. These processes correlate to dynamic interactions among the multiple components of the software application 76, including feedback and feedforward mechanisms and learning mechanisms to allow the software application 76 to evolve with the specific needs of each user and to evolve on a user-independent basis to improve the operation of the software application 76 as a whole.

The operation of the SAM agent 130 and its interaction with some of the other modules will be described with respect to FIG. 4. In step 200 it is contemplated that a user will begin his or her interaction with the software application 76 for the first time. More specifically, the user will instruct the browser 90 being executed by the client 66 to receive interactive screens, or web pages, from the web server 62 executing the software application 76 by way of the network 64. The user will be presented with some introductory screens and graphical user interfaces which present the premise of the software application 76 to the user. These screens include information about the science of human attraction, forums for discussions relating to interpersonal relationships, tours of the web site generated by the software application 76, and other relevant information. Should the user be interested in attempting to meet other individuals using the software application 76, the software application 76 will proceed to step 205 such that the user can begin to customize the interactive screens presented to the user by the user module 132 and to customize the user's guide and host while interacting with the software application 76, more specifically, the user's SAM agent 130. It is noted that the software application 76 operates for multiple users at the same time, such as users 68 executing browser 104 and communicating with the web server 62 over the network 64. It is further noted that the users 68 interact with the software application 76 in much the same way as user 66 will interact with the software application 76. Therefore, the following description of the various modules of the software application 76 although described from the viewpoint of a single user 66, is equally applicable to multiple users 68.

In step 205, the user customizes his or her SAM agent 130. More specifically, the user can select the gender of the SAM agent to be either male or female. Other customizations include choosing an accent for the SAM agent 130 such as American, Southern, British, computer-synthesized voice, comic, or any other voice type selected from a menu of possible accent and personality types. The gender and accent type are combined by the SAM agent module 130 when transmitting audible messages and images from the software application 76 to the user. Another customizable feature includes selecting the type of music to play in the background for the user. It is noted that the user 66 may elect to skip these initial customization features of the SAM agent and defer selecting them at a later time. In this case, default SAM agent settings will be used in the meantime and/or the software application 76 will allow the SAM agent to evolve for the user on its own. The SAM agent can also be customized or evolve over time to act as more of a friend or more of a mentor to the user in the SAM agent's interaction with the user.

Next, the user is requested to fill out a basic questionnaire about himself or herself in step 210. Example questions include whether the user is male or female, and the gender they are attracted to. Other questions can include whether the user is looking for romance and, if so, on a long or a short-term basis. As an alternative, the user may be looking for friendships or companions on a long or a short-term basis.

It is recognized that the user may have questions about his or her experience in interacting with the software application 76 at any time. Therefore, in step 215 the SAM agent module 130 is programmed to answer user questions sent to the web server 62 using a graphical user interface on the client 66 which preferably allows the user to enter a question using either natural spoken language or natural written language. Using information stored in the coach module 50 the SAM agent 130 will attempt to answer the user's question(s) and structure the response(s) in an appropriate manner for the specific user. As the software application 76 learns more about the user, more detailed and more specific tailoring of the responses can be made for the user. In the event that a user asks a question for which the coach module 50 does not have a predetermined response for, the SAM agent 130 is programmed to tell the user that the SAM agent 130 will research this issue and respond at a later time. The SAM agent 130 can conduct this research directly using an Internet search engine or direct the question to a human administrator. For example, if the user asks, “How do I deal with hair loss?” the software application 76 may research this issue and respond with advice or an article from a qualified doctor. This information can be retained by the couch module 50 for future use and updated on a periodic basis.

The opportunity for the user to ask questions is not only important to keep the user fully informed about the user's interaction with the software application 76, but the questions, both in terms of content and language used, is used by the SAM agent module 130 and customized module 22 to develop insight into the user's comfort level and personality characteristics.

The software application 76 attempts to match compatible individuals based on a wide variety of criteria. This criteria and related information about the user is collected using various assessment collection modules, such as the physical module 146 and the personality module 148. Therefore, in step 220 the SAM agent 130 will manage the user's interface with the various assessment data collection modules to be discussed in more detail below. The SAM agent 130 will refer the user to the data collection modules early on in the user's interaction with the software application 76 to begin to establish a knowledge base about the user and to start to match the user with potentially compatible individuals. However, the data collection modules can be used more than one time and in different manners to continue to gain information about the user and refine the software application's ability to match the user.

In addition to the tests and evaluations conducted by the data collection modules, the SAM agent module 130 will collect additional information about the user to continue to build the implicit assessment of the user in step 225. Any data collected about the user is stored in the user database 134. Step 225 may include various tests which the user is requested to take such as a Myers-Briggs evaluation, as is known in the art. Additionally, the information collected in step 225 may include conclusions generated from various aspects of the user's behavior and patterns in the user's behavior. For example, the SAM agent module 130 is programmed to track what items, articles, features and activities that the user views or participates in that are connected to the web site generated by the software application 76 and for how long the user engages in those activities (e.g., does the user study and thoroughly read an article or view the article briefly and discard it). This information, also known as data mining, can help to construct the user's implicit assessment. Similarly, if the user is drawn to articles and features concerning personal appearance, the SAM agent module can use this information to tailor information presented to the user knowing that the user is concerned about his or her own personal appearance.

Another useful information collection technique is mapping the user's response to questions generated by the SAM agent 130 on a 3-dimensional reaction scale. This includes a salience reaction, or how long the user took to respond to the question; a valiance scale or whether the user gave a positive or negative answer such as “I liked this comic strip” or “I disliked this comic strip”, and an arousal scale which measures the reaction strength along a range from a weak or calm response to a strong or excited reaction. The salience dimension is rated along a scale ranging from a slow or contemplative response to a fast or top-of-the-mind reaction. In this way, the learning and pattern recognition aspects of the SAM agent module 130 and the customize module 22 can generate a user profile having information with regard to what traits the user has a great connection with and those traits the user has a low connection with. This technique is used again with respect to the explore module 30 and the data collection modules as discussed in more detail below.

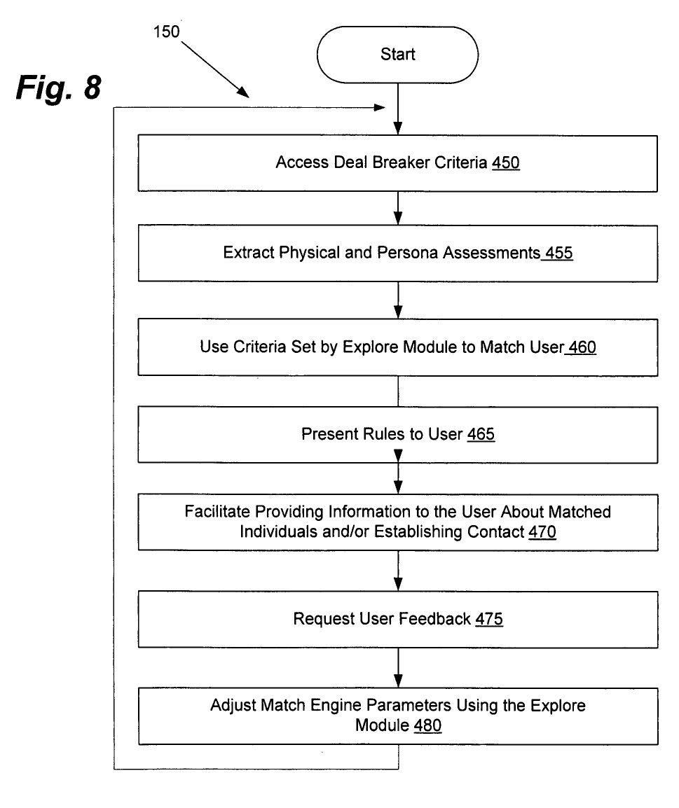

Once sufficient information has been collected about the user the SAM agent module 130 will direct the user to the explore module 30 and the match engine module 150 in step 230. These modules and their operation will be discussed in greater detail with respect to FIG. 8. However, based on the user profile as collected by the SAM agent module 130, the SAM agent module 130 instructs the explore module 30 to alter various search criteria which are ultimately passed to the match engine module 150 for use during the match engine module 150 algorithms. The SAM agent module 130 also serves as the user's host in introducing the user interfaces of the explore module 30 and customizes the content of the explore module 30. For example, the SAM agent module 130 will assist the explore module 30 in customizing the risks and parameters presented to the user when establishing match engine module 150 search criteria.

Once a user has been matched with other individuals, the user may decide to find out more about that individual. Therefore, in step 235 the SAM agent 130 will manage the user's interface to the connect module 154. More specifically, the SAM agent 130 will help the user build a relationship with the other individual. For example, the SAM agent 130 may assist the user in making decisions about how to approach that individual such as sending an e-mail or engaging in an on-line interactive experience. The SAM agent 130 will encourage the user to ask the other individual about themselves and provide question suggestions. The suggestions can be selected from a question database or geared to focus the user toward an interesting attribute about the other individual known to the software application 76, but not the user. The SAM agent can also facilitate a first personal telephone call or first personal meeting between the matched individuals. The SAM agent module 130 is programmed to help the individuals well into their relationship. For example, the user can approach the SAM agent to access information about interpersonal issues that arise during the dating process, ideas for places to have a date, ideas for travel together, and the like.

The SAM agent module 130 is programmed to engage the user in various intervention activities in step 240. These activities include the programs run by the enhance module 144, the features and content from the features module 138, connecting the user with other users trying to accomplish similar goals via the connect module 154 and present the user with various items of electronic commerce from the electronic commerce module 140. As mentioned above, these tasks can be accomplished by displaying information targeting for the specific user on web pages presented via the user module 132. As a specific example, assume the user has a shyness problem. The SAM agent 130 may present articles, interviews or programs to the user regarding shyness via the features module 138. As part of a enhance program, via the enhance module 144, the SAM agent 130 may suggest that a user enter into a shyness enhancement program and explain the options contained therein. As part of this program the user may have an assignment to smile at a stranger during the course of the day. The SAM agent will remind the user to accomplish this task. In another example, a particular exemplary individual may have trouble feeling in touch with their sexuality. As an option to overcome this feeling the SAM agent 130 may suggest the user to buy a sex toy and direct the user to advertisements or items for sale through the electronic commerce module 140.

In order to identify those enhancement programs, connectivity programs, features and e-commerce to present to the user, the various programs, features and electronic commerce items are coded and stored in the coach module 50. The coded items can be easily searched, linked to specific users and presented to the user as it is appropriate, depending on the user's questions, concerns or goals. Furthermore, the SAM agent 130 can be used as an infomediary in order to screen and filter news articles to present to the user. For example, a particular user may be interested in sports and Italian cooking. As news articles become available on these subjects they may be presented to the user. Furthermore, the SAM agent 130 can act as a personal shopper for the user. For example, if the user desires taking a vacation, the SAM agent 130 can use the constructed user profile to suggest particular vacation activities to the user. More specifically, if the user is known to like outdoor adventure activities and upscale shopping and dining, the SAM agent 130 can seek out and suggest appropriate vacations such as a ski trip to Vail, Colo. The SAM agent 130 an also act as a personal assistant for the user, but reminding the user of certain events, on-line. A more detailed explanation of the intervention methodologies used by the software application 76 will be described in greater detail below in the section entitled intervention.

During the course of the user's interaction with the software application 76, the SAM agent module 100, in step 245, is programmed to ask questions of the user. The questions are targeted to receive feedback from the user about the performance of the software application 76 in matching the user with other individuals and the user's experience with the various programs and features of the software application 76. This information is used to further construct the user profile and to customize the SAM agent 130 for the specific user. In addition, the SAM agent 130 is programmed to ask the user for permission to engage in certain activities described herein. For example, the user may opt out of being presented with electronic commerce items or from presenting a picture of the user to other users without permission. Obtaining feedback from the user can also allow the SAM agent module 130 to determine whether the user is being forced into activities the user does not care about or at too fast a rate. Alternatively, the SAM agent may discover that the user could use more encouragement.

Underlying all aspects of the software application 76 is an informed consent by the user for the software application 76 to engage in the various activities described herein. Therefore, the feedback received from the user is used to establish boundaries regarding the types of information collected from the user and how that information is used by the various modules of the software application 76.

As mentioned, all information collected from the user is used in generating the user profile, however, the software application 76 and the SAM agent module 130 in particular, are programmed to recognize patterns within user's responses and behavior to make global improvements in the various artificial intelligence agents when interacting with any of the users 68 (e.g., users b . . . N) in step 250. In step 250, the software application 76 learns from the aggregate user response to the system and uses adaptive reasoning to perform functions such as how to ask particular questions to users, how to present various pieces of information to the users, and the like.

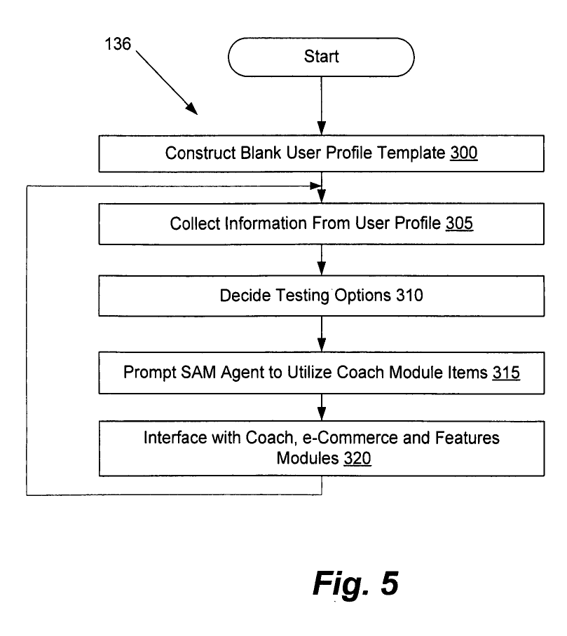

As indicated, the steps described in the flowchart illustrated in FIG. 4, as well as the flowcharts yet to be described, are merely illustrative of one embodiment of the invention. More specifically, these steps can be taken out of order and/or performed concurrently. Some of the steps may be skipped by certain users. Certain steps are also repeated one or more times. Referring now to FIGS. 3 and 5, various aspects of the customize module 22 will be described. The function of the customize module 22 is to assess available information about the user and optimize the use of this information in order to create an efficient and effective experience. To assess user information, the customize module 22 pulls from several possible information sources: (1) demographic and other data gathered by a prior application which transfers the user to the integrated connection system (e.g., a web-site affiliate refers a user and their online demographic profile); (2) user's recorded behavior on the site to date (e.g., most common search query); (3) explicit self-report information gathered in a questionnaire submitted by the system; (4) results from any preference or attribute assessment; (5) record of use of any other component (e.g., performance enhancement course); (6) feedback on any assessment, report, first date outcome, etc. The steps of the customize module 22 are iterative and repeated throughout the user's interaction with the software application 76. The information ultimately stored in the user profile template is the user profile used by the SAM agent 130 and customize module 22 in carrying out the features of the software application 76 described herein.

When a user logs in for the first time, such as in step 200 (FIG. 4), the customize module 22 constructs a blank user profile template in the user database 134 in step 300 (FIG. 5). Any transferred information regarding the user is established within the new profile. Each piece information is potentially relevant as a predictor of other information. For example, knowing that the user is a male, one could predict based on personality research that he will be a Myers-Briggs “T” or “Thinker” rather than a “F” or “Feeler” 3 out of 4 times. The relationship between information points can be estimated via: (1) established statistical correlations or conditional probabilities via empirical studies; or (2) the observed co-occurrence of the two information points among all users to date. These links would be maintained in a data base reference table. This table would be continually updated manually by an analyst or via logic that automates the statistical calculations.

Thus, for known links between information or data points, one confirmed fact or estimate offers the system a “best guess” of the likely state of another point. The above example of estimating a missing piece of information via its correlation with known information is the most straightforward calculation. However, it is also possible to estimate missing information via multiple other data points and even when no directly correlated data is known. First, using Linear or Logistic Regression or Path Analysis (common statistical software techniques) the contribution of several known pieces of data can be considered jointly in making the best estimate of the key missing data. If no immediately related piece of data is known 3 data points are pulled from the reference table: (1) the key or focus data, (2) the related but also missing data, and (3) a third factor with data and a known correlation with the second mediating factor. Again, using Linear or Logistic Regression the most likely value of the mediating factor is calculated based on the known data, which in turn is used to estimate the focus data. This process will be referred to as “triangulating” data points, reflecting that three variables and their relationship to each other are used to estimate missing variables within the triangle. Assuming the links between variables meet a pre-established minimum of statistical significance, the resulting prediction should be more accurate than a random or base rate estimate. One skilled in the art will recognize that emerging statistical techniques regarding estimating missing data for survey research are also potentially applicable to this function.

If the customize module 22 logic triggers an invitation to an Enhance course, the module's logic can present the most relevant course to the user. If there are 5 factors which differentiate which course should be prompted (e.g., gender, body type, shyness scale score, and neuroticism scale score), a pre-set algorithm would apply the 5 variables to the prediction equation. If data is missing on one or more of these factors, the calculation could potentially use only the data available or choose a course at random. However, the most accurate and thus the most relevant prediction would follow from use of all 5 data points. By triangulating the missing variables (e.g., gender, shyness) with related known variables (e.g., occupation, income, number of friends) the “best guess” estimates could be calculated also.

The customize module 22 also plays an essential role in optimizing the length and accuracy of attribute and preference assessments. The Physical Attraction module 146 and Persona Attraction module 148 consist of multiple sub-tests. All tests involve presenting items or some form of stimuli (e.g., photographs, words, videos) to which the user reacts by making a rating. Traditional tests have a pre-set number of items given in the same order. With the advent of computers, measurement researchers developed “adaptive testing” techniques whereby an answer to one item cues the next item among a set of choices with the greatest potential information value (to accept or reject a certain hypothesis or estimate the item query is intended to answer). One skilled in the art would recognize that logic informed by “Item Response Theory” would also aid in this optimization process.

Such functions can reduce the number of items presented by over half and at the same time substantially increase the validity and reliability of the results. The customize model 22 in conjunction with the Physical and Persona assessments plays the adaptive item selection role. The customize module 22 decides the best starting point for either assessment. It begins by checking in data base tables which tests have been completed. Since users can take various tests over time, many users will have incomplete sets of test results. Therefore, in selecting the best sub-test to introduce and the best item within the test to present, the module calculates the best predictor of the user's end result to the test. Because the reference tables have correlations among all possible data points and a specific final score, the score can be estimated via multiple known variables or triangulated based upon links with other missing data. Next, the Persona module 118 or Physical module 116 enters this estimate into adaptive testing logic to pick the most efficient test or item.

The information to complete the user profile is collected in step 305 which overlaps with many of the steps illustrated in FIG. 4, such as steps 205, 210, 215, 220, and 225. As information is collected about the user, the customized module 22 shares this information with the SAM agent 130 to assist the SAM agent 130 in evolving and becoming more user-specific. For example, as the customize module 22 collects an initial set of information from the user, the customize module 22 can decide when and what data collection module (physical module 146 and personality module 148) testing options to present to the user in step 310. As another example, in step 315, the customized module 22 prompts the SAM agent 130 to search the coach module 50 for basic advice and guidance features and programs that are coded to correspond to characteristics of the user. In step 320 the customize module extracts items from the coach database 50, the e-commerce module 140 and the features module 138 which may be of relevance to the user.

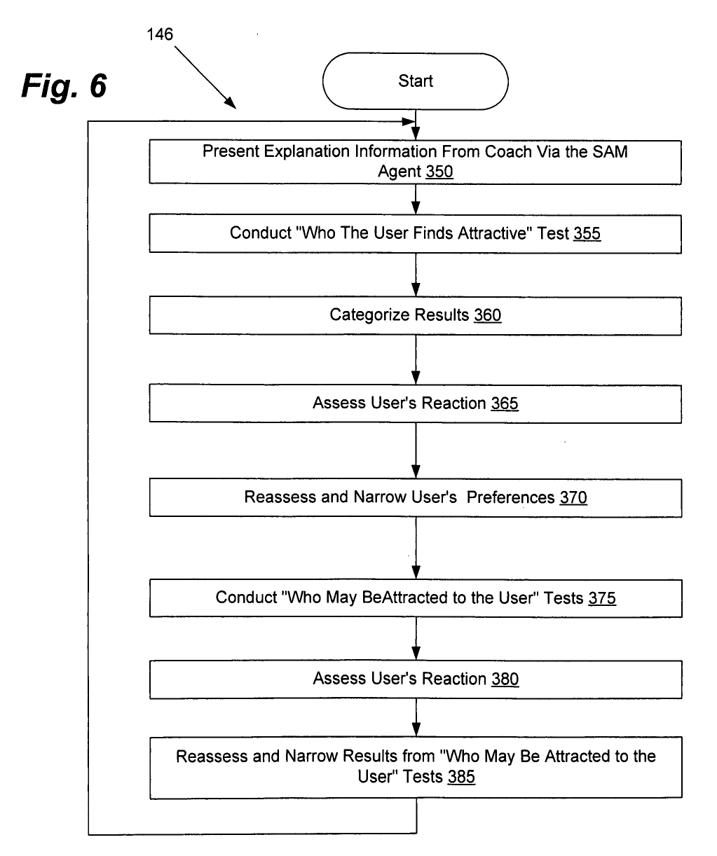

Turning now to FIG. 6, a flowchart of the operation of the physical module 146 is illustrated according to one embodiment of the invention. In step 350, the user is presented with an explanation of the physical module 146. More specifically, the software application 76 accesses physical module explanation information stored in the coach module 50, structures the information using the SAM agent 130 and displays the information to the user via the user module 132. The explanation contains some of the techniques used by the physical module in determining who the user may be physically attracted to and what persons may be physically attracted to the user. After the user has been presented with this information and questions from the user have been addressed by the SAM agent 130, the physical module 136 proceeds to step 355. In step 355 the physical module 136 presents the user with one or more tests to determine what physical characteristics the user finds attractive.

One test presents a rotating series of photographs in a matrix (e.g., 3×3 photo cells). Users can pick only ones they find attractive, unattractive, or any such criterion. Logic continually pops up new photos in the matrix to replace ones the user has picked or ones they have ignored (after a preset number of seconds). Logic can be set to present a series of sorting questions that allow photos to be ranked and categorized in different ways. (e.g., global attraction, sexual attraction, approachability).

The speed at which this and other tests present stimuli to the user is designed to limit the amount of time user's can consciously evaluate (or censor) his or her choices. One skilled in the art will recognize that a moderate to fast speed reduces conscious control and optimizes automatic, unconscious, or implicit choice. Similarly, the pattern of many photos rotating through a screen reduces a linear and overly analytic focus, in favor of implicit choice.

Another such test involves presenting questions to the user such as “Who do you find more physically attractive?” or “Who would you rather go on a date with?” along with images of two individuals. The user is asked to select one of the images via a user interface (e.g., keyboard). Using a variety of questions and a variety of photographs the physical module 146 can, over iterative trials, narrow down what types of people the user is physically attracted to. A series of decision trees can drive the logic or a more flexible adaptive system for presenting choices would also apply. A database of hundreds or thousands of specially selected images is employed. The testing starts with pictures to narrow down the user's preference as to race, build, and other general characteristics. From there, further refinements can be made to analyze features such as facial structure, hair color, breast size, waist-to-hip ratio, leg length, and any other physical attributes. In addition to stimuli choice, the response speed is also recorded and can be indicative of the salience or awareness of the preference. A user may also be given only a limited amount of time in order to respond so that an innate response can be ascertained (e.g., a matrix of photograph options can be presented and replaced in fast order). As will be discussed in greater detail below, these results are characterized, confirmed and re-assessed using various other testing techniques.

Other testing approaches include presenting single photos to be rated on an ‘interest thermometer’ which is designed to capture both the valence and intensity of user's reaction to each photo, with large buttons on either end of a metered (e.g., 9-point) scale representing ‘total turn-off’ to ‘total turn-on’ and then incrementally smaller buttons on either side leading to a middle ‘neutral’ reaction button;

Another approach would offer poorly resolved images to the user such that facial features cannot be determined but the user's preferences with regard to basic shapes, sizes, color tones, and the like can be assessed. Once these are assessed, images with increasing resolution can be presented to the user using a hypothesis-driven adaptive algorithm to construct a best guess as to what types of persons the user is physically attracted to.

Next, during step 355 and step 360, a categorization technique involves placing images from the database used during the step 355 into four self-explanatory categories such as user's type, “gray zone,” “nice to look at, but user probably not attracted to,” and “not the user's type.” It is noted that the “user's type” category may include more than one variety of basic appearance classifications. For instance, the physical module 146 may conclude that a male user is drawn to Caucasian women and to African-American women.

All photograph or item presentations can be pre-set or customized to the user. As noted in the custom module 22, an adaptive system can consider each choice as an indicator of a preference, which can then trigger other stimuli with especially high statistical sensitivity and specificity.

At this point, the physical module 146 via the SAM agent 130 will work with the user to assess the user's reactions to the foregoing testing experiences in step 365. Via adaptive testing, as noted above, clarification may involve additional testing techniques or items to refine the physical module's hypothesis. The physical module 146 will assist the user in refining the conclusions made regarding the user's physical attraction preferences in step 370. The user may also wish to interact with others attempting to define their physical attraction preferences using the connect module 154.

The Physical attraction assessment has a brief version (referred to here as, Mini-Physical) that offers users a quick way to explore the test and get initial results. Mini-Physical and a brief report of the results are designed to be forwarded via e-mail to friends and family, as a means of expanding the user base. Since the Customize module is designed to optimize the use of limited information, the results from Mini-Physical offer an interim means of making estimates of other unmeasured dimensions and conducting searches. Obviously, the Mini-Physical results also offer more information that the customize module 106 can use to present the most efficient set of items in the full version of the assessment.

Next, the physical module 146 will conduct tests to determine who may be physically attracted to the user in step 375. Four main testing approaches are contemplated in step 375. First, the user is asked to take a survey containing questions about the user's appearance. Example questions include user's hair color, eye color, skin complexion, race, hairstyle, height, weight, physical measurements, etc. The second test involves presenting two or more images of individuals on the computer screen and requesting the user to press a corresponding key on a keyboard connected to the client 66 to identify which of the images the user looks more like. This procedure is repeated to progressively narrow the field down to one to five individuals starting from a database of preferably hundreds or thousands of images. This test is very similar to the test conducted in step 355 where the user is asked which image of a person the user finds more physically attractive or which one they would rather go on a date with. Informing the selective presentation of photos is logic which associates each picture with the most similar other according to a weighted set of features. Adaptive testing logic, as mentioned above, would also inform which photograph to present among a set of associated photographs in order to gain the optimal information on similarity.

A third test is conducted by coding a photograph or photographs of the user. The photograph is obtained by electronically transmitting a digitized photograph of the user over the network 64. Alternatively, the photograph can be scanned with a scanner connected to the web server 62. Image analysis software, as known in the art, can be employed to analyze the photo to derive values for feature measurements that are indicative of physical appearance. The variables include items such as nose length and width, eye spacing, the degree of ear lobe attachment, skin tone, etc. Variables which cannot be coded using automated procedures can be manually determined by trained coders and entered into the user database 134 by a human operator.

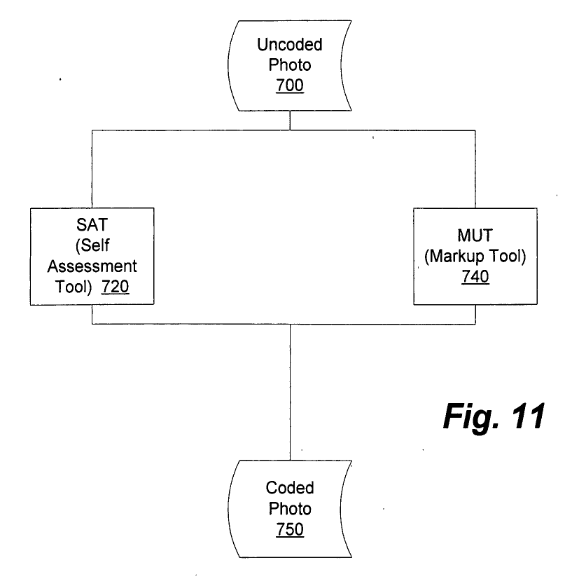

In an embodiment of the invention, a user's appearance is coded using a photo-coding process. As set forth in FIG. 11, a photograph of a user (uncoded photo) 700 is subjected to at least one of two tools, namely a self assessment tool (SAT) 720 and a markup tool (MUT) 740 to arrive at a coded photo (750). In an embodiment of the invention, an uncoded photograph 700 is submitted by a user for measurement and assessment. The user provides information regarding their preferences and attributes via the SAT process 720. Following the SAT process 720, the uncoded photograph 700 is subjected to the MUT process 740. During the MUT process, the uncoded photo 700 is assessed for global attributes, subjective features, descriptive features and facial measurements by human facial coder using a semi-automatic process. As a result of the application of the SAT and MUT processes, a coded photograph 750 is generated which contains a user's assessment of their preferences and attributes combined with a determination of the user's attributes by a third party using a semi-automated process.

Once a majority of the variables have been determined, the user is categorized with a pre-determined group of images of persons who share similar characteristics. Here also, the capacity of the customize module 22 to triangulate the values of missing features based on known values can be leveraged to aid the physical user assessment estimates.

As will be described in more detail below, the information about the user's appearance is used by the match engine module 150 to facilitate a match between what the user looks like and what other users may find attractive.

Upon the completion of step 375, the physical module will assess the user's reaction to the testing conducted in step 375 in step 380. Step 380 is very similar to step 365 where the user is asked questions about the user's experience and requested to provide feedback about the operation of the physical module 146.

Furthermore, in step 385, the physical module 146 will reassess and narrow the results from the tests conducted in step 375. More specifically, the user may be asked to provide a description or identify images of the types of persons they have in the past, found to be attracted to them. The user will also be presented with a number of individuals who the software application 76 believes may be attracted to the user and the user will be asked whether the user agrees with the hypothesis made by the physical module 146. To further refine who may find the user attractive, images of the user can be presented to other individuals (including matches for the user identified by the match engine 150). These individuals are asked to rate their attraction to the user such that the physical module 146 can check and reassess the hypothesis made about who may or may not be attracted to the user and whether this user is appropriately categorized with similarly looking individuals. At each step, the user is given the opportunity to interact with others who are in the process of using the physical module 146 via the connect module 154.

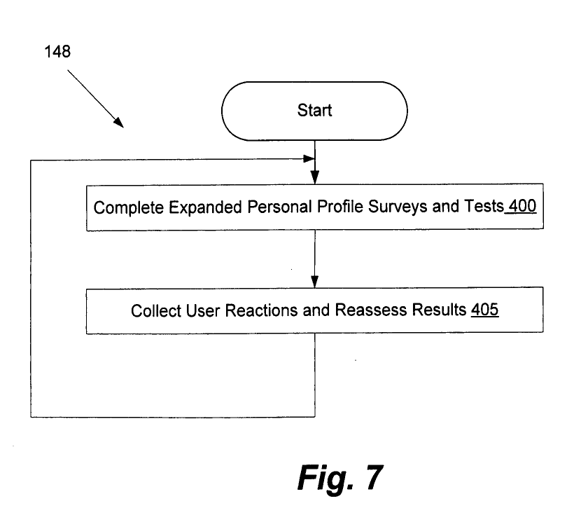

Referring now to FIG. 7, the personality module 148 will be described. Similar to the physical module 146, the personality module 148 will present an explanation of the personality module 148 to the user and allow the user to interact with others who are in the process of using the personality module 148 via the connect module 154. The personality module 148 collects information used to populate the user profile and adds to the data collected by the SAM agent 130 and the customized module 22. In addition, information gathered by the personality module 148 is used to identify personality traits of the user to be used by the match engine module 150 and to determine what personality characteristics the user is seeking in other individuals.

In step 400 the Persona module 148 requests the user to complete a brief self-report survey to cover aspects of his or her interests that are not covered in other tests. The survey may contain questions regarding what type of person the user is seeking, what type of relationship the user is seeking, what interests the user has in terms of recreational, academic and professional interests, whether the user is outgoing, enjoys music, political involvement preferences, whether the person views themselves as optimistic, whether they enjoy going to social gatherings and what kinds of social gatherings, preferences regarding pets, interest in having children, how they feel others view their personality and a variety of other questions. An expanded personality profile survey conducted in step 400 could include existing tests (such as the Myers-Briggs Type Inventory) which are typically administered as questionnaires. As found in the physical module 146, the primary Persona tests optimize the use of non-questionnaire formats to make the experience fun and entertaining and targeted more toward implicit rather than explicit choice. The rate and pattern of stimuli presented minimizes self-monitoring biases in responses. In the first test of the user's personality attributes, titled: “Words that describe me,” users are first presented with a matrix of words (framed in small boxes in a 2×3 frame) that rotates new words in or by a stream of words that float across the screen. Users are asked to click on words that they or their friends would say describe them (e.g., shy, ambitious, organized, logical). The second test, titled “When I am not at my best,” uses the same format for presenting words in a continuous, fast-paced manner. Here, the focus is on words that would describe the user when s/he is stressed, tired, or sick (e.g., talk more than most, swayed too much by emotion, late for appointments). This is a unique approach to personality testing, which highlights that knowing how people's quirks or how they behave when they are stressed is very relevant to predicting compatibility. The third test focused on the user's personality attributes presents a series of forced-choice pairs that depict two extremes in behavior. Each represents an extreme on specific personality dimensions, and here too point to the user's quirks which their ideal partner should like or be able to tolerate.

The next set of Persona tests focus on whom this person is seeking. The test presents a series of descriptive phrases to which the user rates their reaction to someone like this. Using a multi-point negative to positive scale the user can note the extent to which this behavior (e.g., very empathic and compassionate) is a “turn-on” or a “turn-off.” Another test on user's personality preferences presents forced-choice pairs (as in the earlier attribute test) and asks the user: “If your partner where to go to an Extreme, which could you better tolerate.” In both of these preference tests, both positive qualities and quirks or negative qualities are presented in order to assess a full range of dimensions upon which to match.

Similar to the Physical module, the Persona assessment has a brief version (referred to here as, Mini-Persona) that offers users a quick way to explore the test and get initial results. Mini-Persona is designed for widespread circulation of friends and family so they can enjoy the test. It also offers initial estimates that can be used by the customize module 106 to optimize searches and adapt efficient items when the user takes the full version of the Persona assessment.

Another related test is a version of the Mini-Persona that the user can send to friends and family so that they can offer their perspectives on the user's personality. These social ties respond to items seeing which words and phrases best describe the user. A skilled artisan will recognize that gaining this external input substantially increases the validity and reliability of the system's estimation of the user's personality. Users receive a report that compares how friends and family see them versus how they see themselves. This is also an opportunity to identify personality strengths and weaknesses that can later be the focus of the Intervention Activities module 54.

The system includes a number of mechanisms to gather feedback 44 from the user and others as a means of (1) expanding upon the assessment of one's preferences and attributes, (2) observing outcomes of predicted interactions between the user and others, and (3) learning about oneself and facilitating interventions to change attitudes and behaviors.

First, the feedback system 44 serves to gather information that adjusts or adds to any existing information on a user's preferences and attributes. The system includes standard templates for creating electronic surveys that are sent online to peers, dates, bosses, and any other source of information. The system is capable of allowing user participation in decisions concerning from whom feedback will be obtained and subsequently used to modify the estimates of their preferences and attributes in the system. How and the degree to which this is done varies according to the particular embodiment. Nevertheless, the system optimizes user control of the who, what, where, when, and how of the feedback system. For example, the user can control the types of questions that are asked and can even enter a custom question in order to get open-ended feedback.

With the user's approval, the system 44 can also automatically contact people for input after certain events occur or via random sampling of a specific target audience. For example, the system might automatically contact a random sample of dates or potential employers the user has met online after meeting 10 people, and ask for feedback on certain dimensions.

The system 44 aggregates and synthesizes the feedback from a plurality of raters to use for multiple potential purposes. First, the feedback can also be used to adjust estimates of the user's preferences or their attributes. Feedback can serve as a substitute for missing information, expand upon information, or adjust and clarify estimates. The system could potentially operate using only the preference and attribute estimates from the feedback system, thief the user has not completed their self report tests. However, in most cases, feedback is meant to complement other sources of information. When there is agreement, logic can adjust the strength and/or confidence assigned to the attribute or preference. At times, feedback raters may see the user's preferences and attributes differently than his or her self-report. In such cases, the feedback is either used as stand-alone estimates of their own or logic can synthesizes both sources of contradicting information into a final single conclusion score (as described below). Indeed, feedback fits within the existing system's design to accommodate and leverage multiple sources of information and make decisions based on the degree of consistency (or inconsistency) contained in the information (as described below).

One skilled in the art will recognize that self-report information is often inaccurate due to lack of insight or intentional misrepresentation. Peers and other observers can offer insights that the user may not have access to. For example, a user could not fully report how others see her or how others react this her behavior. Thus, this feedback system makes measurement of certain preferences and attributes possible that would not be available otherwise.

A second function of the feedback system 44 is as a means to seek input from users and those they encounter regarding the effectiveness of predicted outcomes. The system offers numerous opportunities for the user to offer feedback to the system regarding the accuracy of its estimates of the user's preferences and attributes. For example, reports that summarize the results of preference or attribute tests provide feedback buttons for all report elements so the user can say whether the test reached the right or wrong conclusion. At any point the system is capable of providing search results, or simply presenting a custom advertisement or product recommendation. Any time a product offering is made the system presents feedback buttons so the user can say whether he or she liked or disliked the offering.

When the user contacts a person recommended by search results, the system seeks feedback from the user on whether his or her reaction was in-line with expected reactions. Contact with a top ranked search result would be expected to result in a positive, successful encounter. To assess the system can automatically send a survey to the user, which asks him to evaluate the encounter.

Similarly, the system can send a survey to the contacted person. Thus, the feedback system can assess the perceived outcome of encounters from both participants' perspectives. Feedback on the encounter can be on multiple dimensions (fitting different domains and performance indicators) and via dichotomous, categorical, ordinal, or continuous scales. In addition, the surveys can assess each person's perception of each other, the encounter, and why the contact was successful or failed via ratings and/or open-ended input.

Once there are multiple feedback observations (based on the user's ratings and/or ratings by contacted people) for any given dimension of a user's preferences or attributes, statistical analysis can be conducted to examine the factors that differentiate positive versus negative outcomes, or expected or predicted outcomes versus unexpected outcomes. Indeed, the gap between expected versus observed outcomes is an error indicator, which becomes a dependent variable for statistical analyses that attempt to reduce the sum of squared errors. For example, if the system estimates that a user and candidate will rate the overall valence of their first meeting as a 6 and their actual ratings are 4, this is gap is squared and recorded. Across multiple dates, these gaps would be estimated, and then once there are 10 or more such observations, the system can automatically run statistical analysis to see the characteristics of the fit between users and candidates that led to the highest actual valence scores and minimized the squared error of the prediction-observed gap.

To infer the reason for the error, the system can rely on both exploratory statistical analysis as well as user and peer feedback on the drivers of poor experiences (see Learning Engine below). One skilled in the art will recognize that a statistical engine can be utilized to automate comparisons between good and bad outcome events to test the differences between the encounters in terms of preference, attributes, and other factors that came into play. If, for example, the analyses indicate that candidates that the user did not like were more likely to have a certain attribute than those who did, then the system can reference logic to automatically adjust the user's preference parameters to reduce the likelihood of meeting someone with this undesirable attribute.

Such adjustments create further customized, user-dependent logic. In addition, the feedback system generates insights that can be used by the system to optimize user-independent algorithms that can be applied to new users.

The third function of the feedback system is as a means of educating the user and offering intervention to modify attitudes and behaviors. The feedback system includes logic, which not only aggregates scores on a dimension across peers or other raters, but also customizes feedback to the user in a report. In order to protect privacy and optimize honest answers, the system would only share synthesized results when at least 5 to 10 contacts with feedback have been made.

Feedback may include, for example, comparisons between how the user sees himself compared to how his friends see him. The feedback presentation focuses on both the user's strengths (behaviors that should be encouraged) and his quirks or shortcomings (behaviors that are perceived as sources of poor encounter outcomes).

The feedback system can draw on expert logic on the most effective ways to present constructive criticism and still motivate the person for change. The system includes means of making automated inquiries to the user prior to giving feedback in order to assess the user's interest in and readiness for feedback. One skilled in the art will recognize that interventions are more likely to be effective, given the system's capacity to customize feedback messages to the user based on the user's interest in and readiness for this information. Such tailored messaging is most likely to motivate the user to take the next steps toward change.

Another related test deepens the focus on implicit assessment of personality, attitudes, and interests. The implicit assessment testing approaches are based on cognitive priming processes. One skilled in the art will know that cognitive priming relies on the theory that positively valenced items and concepts change a common positive conceptual space in an individual's mental functioning, and similarly, negatively valenced items and concepts share a common negative conceptual space. For example, taxes are almost universally thought of as a negative item. It would share the same conceptual space with adjectives such as bad, sad, and poor. On the other hand, positive items such as a puppy dog will share a common space with adjectives such as good, happy, and rich. Once an individual is presented with an item having a certain valence other items or adjectives having the same valence will be more readily accessible.

Thus, a person's personality profile can be calculated by summing the number of positive, neutral, and negative response to each item in each personality trait (e.g., words linked to extroversion vs. introversion). This approach is also suited to measure censored, unconscious, or disavowed attitudes, personality, and interests. A variety of Persona tests follow from this approach. For example, an image (e.g., picture of a party) can be presented at the top of the screen and the user is asked to pick one of two descriptive words at the bottom of the screen (e.g., loud Vs. exciting). The choice and the timing of the response suggest the evaluated valence of the image and the accessibility or salience of the attitude.

Another such test would present a positively valenced adjective word, such as “nice,” preceded with a similarly positive stimulus item, such as a photograph of a flower. When the user is asked to pick one key if the image or word is positive and another if it is negative, the reaction time given this series of positive should be fast (e.g., in about 400 ms). If the word “evil” is presented after the flower, the reaction to the word would be negative for all users, but the reaction time would be slower (about 1.2 seconds) since items of different valence occupy different mental space. In this way, response time can be seen conceptually as a measure of distance between an image and its positive Vs. negative associations. The pairing of images can be at a perceivable rate or such that the anchor negative or positive stimuli is presented subliminally or without conscious recognition.

Each user's reaction time is first statistically standardized relative to their typical response time and then standardized again relative to a representative sample of people. In this way, response time is expressed in standard deviation units above and below the mean reaction time for the norm sample. One with a response time that is 2.0 standard deviations above the mean would have had an abnormally slow reaction time. This user's score on the target personality dimension would be calculated by summing the reaction times and positive, neutral, and negative response to each item representing personality trait.

Although the description of the Persona assessments focused on lexicon tests, the Persona tests are also suited to test emotional reactions to photographs and other images. The Persona stimuli, as with all other assessment items, can be pre-set or customized to the user. The adaptive system logic can trigger strings of stimuli or items that best clarify the user's categorical type or the strength of reactions relative to a particular personality dimension.

All the items or stimuli prompted by the customize module 22 for the Physical and Persona assessments are retrieved from continually updated databases. The integrated connection system is designed to link to a plurality of databases with potential words, photographs, and other images that can be used in any test. Given the huge volume of images and the impossibility of direct human consideration of all possible entries, the customize module 22 is designed to prompt random images into the Physical and Personal tests. By introducing new test items in a systematic manner across users, the customize module 22 can measure each item's relative contribution as a predictive factor. Thus, new and more effective items can be added to tests for all or specific subgroups of users, in way that would be impossible depending solely on human efforts. This furthers the role of the customize module 22 as an experimenting and adaptive element of the system.

In step 405, the personality module 148 categorizes the results from the surveys and tests conducted in step 400 to construct an assessment of the user's personality traits and an assessment of the personality traits the user finds desirable. Similar to the user reaction steps 365 and 380 and the re-assessment steps 370 and 385 found in the physical module 146, the personality module 148 has processing to glean the user's reaction to the surveys and tests and evaluate and re-assess the results derived by the personality module 148. More specifically, the personality and physical modules share common overlapping report interfaces where the user can review his or her combined physical and personality profiles and assessments, both before and after matches have been made with the match engine 150 to continue to refine the information collected about the user and to target compatible matches.

One such technique for re-assessing the results of the assessments made in the personality module 148 is to display short video clips of an actor portraying multiple personality types, to which the user is asked to rate a multi-point negative to positive reaction. The video clips could also present enactments of ex-boyfriends or ex-girlfriends commenting on the strengths and challenges of being with a person like this. Again, the user would be asked to rate their reaction to these remarks and rate the final overall reaction to a man or woman with this personality. In addition, the user could rate the characters on multiple dimensions which parallel the characteristics contained in the personality preference of the user. This may confirm information already gathered or may highlight differences between what a user may expressly state and may implicitly indicate through the subliminal testing approaches. For example, the user may state that he prefers ambitious, career-oriented women but in his reaction to the actor vignettes in the video clips he may indicate that he is actually more attracted to the easy-going, down-to-earth style. As explained in more detail below, these differences are addressed by the explore module 30 so as to maximize the effectiveness of the match engine module 150.

Another test conducted in step 400 is a deal breaker test. More specifically, deal breaker traits are traits that the user either requires in a potential match or is unwilling to tolerate in a potential match. Typically, the deal breakers should be limited to two or three characteristics and address very specific items of information. Examples of deal breakers may include religious affiliation, geographical limitations or willingness to have children.

Referring now to FIG. 8, the match engine module 150 and the explore module 30 will be explained in greater detail. Starting in step 450, the match engine module 150 reads any deal breaker criteria from the user database 134 which the user has specified during any of the foregoing data collection mechanisms. Next, the match engine 150 will extract the assessments derived by the physical module 146 and the assessments derived by the personality module 148 from the user database 144 in step 455. The information contained in the physical and personality assessments is used by the matching algorithms to screen in people who the user may share mutual physical attraction with and those who may have compatible personalities. At the same time, the matching algorithms are used to screen out those persons with mismatched tastes.

The assessment information provides the match engine 150 information that would normally be used by an individual to form a Gestalt impression of another individual. Therefore, the match engine 150 can shortcut and facilitate bringing together people who are mutually attracted to each other and are compatible with each other. More specifically, the match engine 150 recognizes the importance of physical and non-verbal qualities in attraction to automatically screen in or screen out people with certain profiles. In addition, once a user chooses to have an on-line encounter with a potential partner, he or she has access to information about the other person's user profile which can help facilitate these early encounters. Referring to the expression that if people are to experience a romantic spark by finding love at first sight, then this experience requires the element of sight. Using the physical and personality assessments, the match engine 150 can initially substitute for the user's eyes and ears to approximate which individuals may truly be compatible with each other and allow the user to explore other possibilities with potential partners who they may not have otherwise thought compatible. In summary, the match engine 150 provides the users with expanded sensory information of the potential partners, both with visual and verbal information, prior to their first on-line verbal (i.e., written or auditory) exchange. In addition, the overall rate of false positives can be reduced and, if the individual is matched with an individual but determines that the individual is actually not compatible, the software application 76 can learn from that information to provide better matches in the future. Providing the user with expanded sensory information about matched individuals allows the user to form expectations and imaginations of the other individuals faster and more accurately than with prior techniques. This reduces the rejection rate of potential partners once encounters advance to telephone conversations and face-to-face encounters. Therefore, the information screened in and screened out by the match engine 150, and the information presented to the user about other individuals before on-line encounters occur, creates a tool for forming connections between individuals.

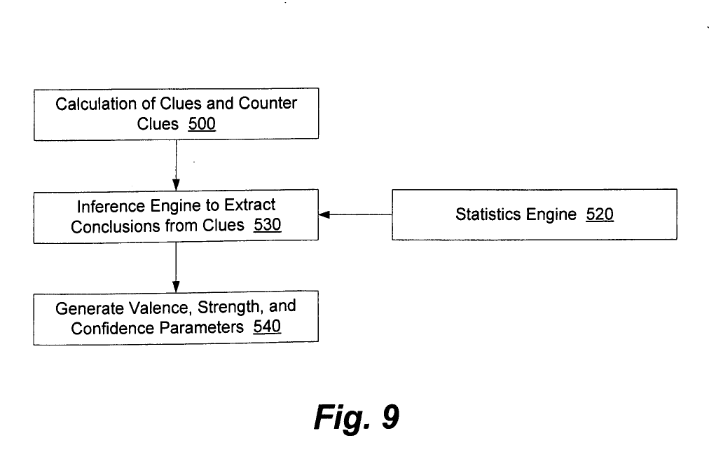

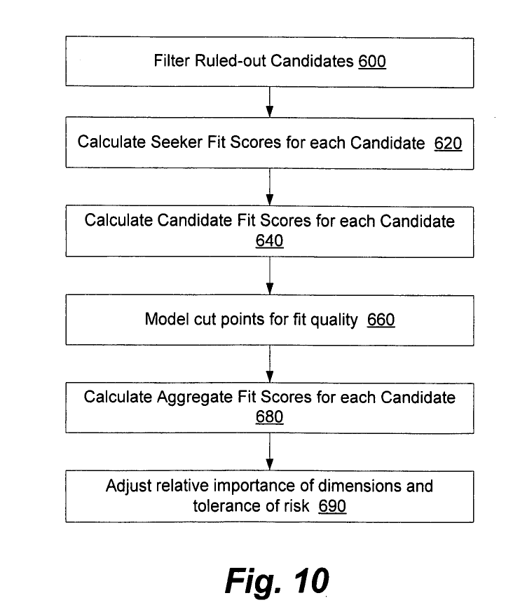

As outlined in FIGS. 9 and 10, a search system involves multiple stages. First, a calculation module 500 sums preference scores and then attribute scores based on the tests. These scores are referred to as “clues.”

The ultimate conclusions regarding preferences and attributes result from considering clues or indicators via different methods and measures. One skilled in the art will recognize that “multi-measure, multi-method” assessments are considered the gold standard in social science research. This system allows for any variety or combination of assessments to be synthesized into common conclusions for the purpose of searching.

As an example of a preference clue, a user's selection of certain words on one subtest of the personality module 148 may suggest he is attracted to extroverts, as indicated by exceeding a threshold of summed ratings of certain words and phrases, which is significantly noted among those with a known gold standard preference. For example, in one embodiment a particular male user might select 7 photos of women with long hair, whereas the average man in the same demographic subgroup who is established to like and date women with long hair selects only 4, offering a clue that the user probably likes long hair. Thus, there can be clues that a user possesses a particular attribute, as well as “counter-clues” suggesting that they do not, such as when the user's self-reports do not align with descriptions by their peers using the feedback system. For example, the user may show a preference for long hair on a test, but his friends may report that he only dates women with short hair.

An inference engine 530 specifies which combination and patterns of clues and counter-clues result in conclusion regarding a preference. Some types of clues may be weighted more highly than others, based on research suggesting the relative validity of subtests in differentiating people with known preferences. In this model, the inference engine is separated from the specific topic or knowledge base, so that the same application can be used for different purposes where multiple sources of inexact information can be aggregated or synthesized into a single conclusion.

The inference engine 530 can function as a rule-based expert system, with pre-set hierarchies and decision trees. However, in an embodiment, the system has the expanded capacity to make unique conclusions per subject based on within-subject analysis and has the capacity to learn and adjust based on observations of outcomes and feedback (e.g., from dates in the current embodiment).

The inference engine 530 can access a statistics engine 520, so that the relative importance of clues in predicting an overall preference can be analyzed via within subject analysis. For example, multiple subtests may result in multiple clues (e.g., significant preferences are found for global attractiveness, age, and height) that can be compared for their relative importance in a separate statistical test (e.g., looking at the predictive power of these preferences in differentiating choices among a new set of photos) via one or more forms of multiple regression analysis.

The inference engine utilizes Bayes Theorem and Bayesian reasoning to combine clues. Probability theory is the oldest and best-established technique to deal with inexact knowledge. One skilled in the art will recognize that if one has benchmarked the proportion of a population with a specific preference, it can serve as the prior probability to which each user's responses are contrasted. For example, given that you have one group of women who clearly like and date men with large noses and another group of women who do not like men with large noses, we can map the percentage of women who found a series of photographs of men attractive or not attractive. The percentage who found the photo attractive form two columns with the rows being the photos of men. Using Bayesian reasoning, we can look at a new woman with unknown preferences and compare her choices with these two groups. If she picks more photos that a high proportion of women who like large noses found attractive, and few of the photos that only women who do not like large noses selected, the calculations will suggest point to a higher probability that the new woman likes large noses that the probability that she does not. Bayes equations can consider a variety of indicators as evidence (or rows), including a series of clues, reactions to individual Personality Test items, or reactions to a series of forced or multiple choice photo tests.

In addition, the inference engine 530 can also utilize fuzzy set theory (or fuzzy logic), which explicitly calibrates uncertainty. With fuzzy logic all estimates are represented as degrees of a preference being true or degrees of membership in a known preference subgroup. The continuum of degrees can be pre-set via experts or via research on characteristics of people in clear and mixed preference groups. One such method allows every possible combination of results to be considered, such that each pattern is assigned a fuzzy degree score.

The inference engine 530 adapts to missing or incomplete information by using statistical approaches for calculating missing values and by continued use of fuzzy logic. One skilled in the art will recognize that multiple statistical approaches exist for estimating missing data, such as comparing the user's responses to others with full information and aggregating their responses to estimate the likely value of this missing element. For example, missing values can be assigned the mean value of their most similar psycho-demographic subgroup. More complicated approaches are available that involve multiple regression or logistical regression to estimate missing values based on available data, based on pre-established weights for the contribution of different items.

Also, data can be triangulated such that known regression equations that explain the relationships between three variables allow one of the three to be estimated by simply knowing two of the sources. Fuzzy logic is designed to accommodate such estimates. Regardless of the fuzzy nature of the clues, the final conclusion is expressed in a continuous score that captures the degree of inexact knowledge from multiple sources (e.g., missing values, inexact measurements). One skilled in the art will also recognize that results can be systematically “de-fuzzified” to arrive an clear categorical conclusions.

In summary, the inference engine 530 can use a variety of statistical approaches including Bayes Theorem and Fuzzy Logic. These tools/techniques are used to evaluate and combine clues from the various subtests concerning each user's preferences (and attributes). With multiple statistical techniques the conclusions from each such method can be framed as clues, which in turn are evaluated to reach a meta-conclusion. Finally, it should be noted that the use of multiple statistical methods also allows the flexibility to have alternate options in case the population and data assumptions or requirement of a particular statistical method. With multiple methods the inference engine can apply one or more valid methods to virtually all users' data.

Next, a process 540 translates raw results into multiple dimensions that make up the preference and attribute parameters. For example, in our model, preferences for specific personality traits, values or interests, and physical features can be gauged on four dimensions:

Valence represents the positive to negative reaction to a feature or trait, based on the user's underlying likes and dislikes. Capturing clear neutral or negative reactions are as crucial to the system as identifying the positive preferences.

Strength represents the intensity or relative importance of a preference, as well as the influence of the interaction certain preference combinations. For example, strength captures how much you like a certain feature (e.g., strong preference for blonde hair), how important it is relative to other things you desire (e.g., blonde hair versus a full figured body), and whether the co-occurrence of preferences changes its impact (e.g., liking blonde hair only when it is long).

Salience represents action potential associated with the preference, which is often expressed in reaction time. For example, a woman may have negative reactions to short height and long hair on men. However, the reaction to height may represent and instant, salient reaction, while judgment of hair is perhaps less clear or more slowly reacted to.

Confidence represents the consistency and clarity of a particular preference, based on observations of how a person reacts to a trait or feature over time or across tests. Uncertainty is present in any assessment due to inexact, incomplete, or unmeasurable data. The confidence gauge (which in some fields is referred to as a Certainty Factor) allows the uncertainty to quantified and taken into account in weighing the relative contribution of one conclusion versus another.

The product of these four indicators results in a total preference score. Weights are used to capture the influence of each of the dimensions. For example, preference for blondes might be positive (+1.0), moderately strong (0.65), immediately noticed (0.89), but only noticed on 1 of 3 tests which reduces confidence in the accuracy of the estimates (0.33). Thus, the product of these weights would result in a total preference indicator.

The searching engine conducts several steps, outlined in FIG. 10, that lead to a ranking of potential candidates and assigns each an overall goodness of fit indicator. Here we refer to the individual conducting the search as the user and the pool of potential targets as candidates. If the search engine is applied in other contexts, including but not limited to job searches, music searches, movie searches etc., the user may be a group or institution and the candidate could be groups, objects, or locations.

In an embodiment of the invention a step in searching involves a filtering stage 600, which narrows the candidate pool by eliminating those that the user would automatically rule-out. Basic requirements like proximity, marital status, smoking and alcohol use, and religion could be triggered as requirements by the user. The attributes identified in the tests as being significantly unappealing to the user would also be filtered as “rule-outs.” Logic would map primary and secondary lists of filters that would be used at times when a large candidate pool has to be reduced before the further steps could be made.

In an embodiment of the invention, a step in searching involves goodness-of-fit calculations 620 of the user's fit with each potential candidate. This can be referred to as the User-Fit-Score. The calculation centers on multiplying each preference with its corresponding attribute. Thus, whether or not the user likes blonde hair corresponds with an attribute that indicates whether or not the candidate has this attribute. Thus, a vector exists for preference scores and a vector exists for the attribute scores per each dimension. As noted above, the vector s of the user's preference scores represents the product of valence, strength, salience, and confidence. Similarly, the attribute scores in vector c represent the dichotomous presence or absence of the feature or trait and the product of strength or confidence assigned to each estimate.

Thus, in this step, given two vectors, s (preference scores per attribute) and c (attribute scores):

Seeker-Fit-Score=s′c/[s]*[c]

Where, s′c represents multiplying the preference and attribute scores for each dimension and then summing these across all dimensions on the vectors. This is divided by the product of [s] (the normed vector of s) and [c] (the normed vector of c). Norming the vector corresponds to [s] as the square root of the sum of squared seek preference scores and [c] as the square root of the sum of squared attribute scores.

In an embodiment of the invention, a step involves goodness-of-fit calculations 640 for how well the user fits what the candidate is looking for, which we refer to as Candidate-Fit-Score. Here the mirror process occurs, with the user's attributes being multiplied times the candidate's preference scores. Thus, the same formula applies, but the vectors correspond to the opposite person in the pair being considered:

Candidate-Fit-Score=s′c/[s]*[c]

In an embodiment of the invention, a step involves a modeling stage 660 where cut-points for User-Fit-Scores and Candidate-Fit-Scores are calculated in order to estimate fit quality. This involves modeling how the user's preference vector will fit will fit with a random sample of the existing candidate pool.

To do so, we rely on a “training set” of attribute vectors drawn from a random sampling of candidates. Training sets should be specific to the population of interest. The user's User-Fit-Score is calculated for all candidates in the training set, and then the user's attribute vector is applied to all candidate preferences to calculate the Candidate-Fit-Scores. This results in a distribution of these fit scores. One might calculate the standard deviation of the distribution of fit scores, and view the fit score corresponding to over one standard deviation above the mean as probably indicating a relatively high fit score.

Alternatively, the fit scores can be ranked, and the scores corresponding to specific intervals can be extracted as cut points. For example, if there are 100 candidates in the training set, the score of the candidate ranked 95th ranked fit score could be viewed as delineating the upper 5% of search results. Conducting this modeling and identifying percentile cut points allows a user to consider a potential match in the context of what he can expect overtime online. A description can be as specific as: “This Candidate's fit with the features you like is in the top 5% of all the fits you are likely to encounter online, and the fit of your attributes with her preferences was in the top 25% of those she is likely to meet.”

Based on research or expert judgment it is also possible to assign categorical descriptors to fits that fall within specific ranks. For example, Candidates with User-Fit-Scores above the 10% threshold and whose Candidate-Fit-Score are above the 20% for that candidate, might be labeled as “Excellent” fits, while scores fitting lower ranks would be assigned other categorical descriptions.

In an embodiment of the invention a step involves search calculations 680 to consider multiple search domains simultaneously. In this embodiment, a user may wish to consider both Physical Attraction and Personality Compatibility simultaneously in ranking possible candidates. Other factors such as personal interests and proximity could also be considered simultaneously in searching and ranking.

The fit across dimensions must be combined to form an Aggregate-Fit-Score. The model allows for multiple methods to be used alone or in combination to determine a candidate's overall fit score or ranking given multiple ranks via multiple dimensions. Aggregation could focus on raw fit scores, ranking of candidates relative to all others, or a categorical translation of the fit scores (e.g., turning continuous scores into ordinal values of 1 to 10). One skilled in the art will recognize there are multiple statistical options to synthesize such information, including multivariate and nonparametric techniques. All such methods allow weights to be assigned to the dimensions such that the relative importance of the scores or ranks on one dimension can be emphasized over the others. Alternatively, using Fuzzy Set Theory, exact patterns of fit scores across dimensions can be anticipated and mapped out such that a given pattern would correspond with specific aggregate fit scores.

In an embodiment of the invention, a step involves a user interface 690 whereby a user can manually adjust the relative importance in searching of any number of dimensions simultaneously, as well as the risk they are willing to tolerate. A user may adjust the extent to which they want the sort to consider candidate's fit solely based on their own preferences (User-Fit-Score) or balanced with whether the candidate is likely to be interested (Candidate-Fit-Score). Finally, the interface would allow the user to adjust the risk they are willing to take in getting an inaccurate match, especially a “false positive.” Those wishing to minimize risk would want to weight most highly the Preference-Attribute pairs where the information is most consistent and clear. All adjustments ultimately translate into weights that would be multiplied times overall dimension scores on specific Preference-Attribute combinations.

Given the foregoing operational characteristics of the match engine 150, in step 460 (FIG. 8) the match engine 150 uses criteria set by the explore module and searches each user database 134 for a compatible match for the user. It is recognized that the user may or may not experiment with the explore module 30 before the match engine attempts to match the user. Therefore, the match engine 150 will use its default programming and information collected about the user to this point to establish compatible matches for the user. In fact, the match engine module 150 is designed to conduct a first search based on user-independent algorithms containing criteria which are selected and weighted according to a model which predicts compatibility for users of this type based on research and studies conducted in the art. Subsequent searches will allow the match algorithms to evolve and become more user dependent (i.e., more customized to the preferences and experiences of the user). For example, the explore module 30 as discussed below, allows the user to customize inclusion and exclusion criteria that the match engine 150 uses to screen potential partners. As an example, the match engine module's default approach may be to begin searching for partners that the user is likely to share a mutual physical attraction with or those individuals classified in the user's “user's type” category. However, as the user gains more experience with the software application 76, the user may be open to considering people who would be classified in their physical attraction category of “gray zone” as long as those persons are compatible in other ways.

Once the match engine 150 has identified potential matches for the user, the potential matches are presented to the user in step 465. Included with the information presented to the user can be the swap items identified by the matched individuals, plus photographs, written descriptions and portions of their personality assessment. Information regarding the level of mutual physical attraction can be presented such as a statement that the individuals are probably physically attracted to each other or a statement that one of the individuals is attracted to the other but probably not vice-versa. A similar assessment of the personality compatibility between the individuals can also be presented.

After reviewing the information presented to the user in step 465 the user may elect to request more information about one or more of the individuals and/or contact one or more of the individuals using the connect module 154 in step 470. Following steps 465 and 470 the user is asked by the SAM agent 130 for feedback regarding the user's experiences with the match engine thus far in step 475. The information gathered from the user at this point is used to help the match engine 150 algorithms evolve to become more user dependent and is based on user reaction to the matched individuals, direct feedback from the users regarding any interpersonal contact made with the matched individuals, and the SAM agent's observations of the members behavior surrounding each potential match and any interpersonal contact using the connect module 154. Direct feedback is derived from users responding to questions sent by the SAM agent to the user regarding the selections the match engine 150 makes.

Users can also proactively submit multiple levels of feedback for any on-line or off-line encounters with the choices made by the match engine 150 using the explore module 30 as discussed below. Users are encouraged by the SAM agent 130 to rate their on-line and off-line encounters with matched individuals along a valiance scale (i.e., negative/dislike reaction to positive/like reaction) and along an arousal scale to measure the strength of the user's valiance reaction (i.e., along a weak/calm to strong/excited scale). A third dimension is preferably captured as the user makes his or her valiance and arousal reactions to the matches made and encounters with those individual, namely along a salience dimension (i.e., a slow/contemplative reaction to a fast/top-of-the-mind reaction). Similar to results obtained using the various assessment testing approaches, the match engine 150 and the explore module 30 can use the valiance, arousal and salience information to evolve a user-dependent algorithm to compare the profiles of various individuals who have the greatest potential connection with the user. Should a pair of matched individuals engage in a prolonged relationship (i.e., more than two interpersonal encounters) the SAM agent 130 will request that the users provide feedback about their relationship. Assuming permission is granted by the users, the SAM agent 130 and explore module 30 will observe multiple factors associated with how the two matched users behave over the course of their relationship. This information can be used to identify conflicting goals between the individuals, determine their openness to risk, help the individuals make trade-offs in reaching their goals and provide feedback to the users that may assist their relationship. For example, the users may be interested in making a weekend getaway and the SAM agent 130, along with other modules such as the e-commerce module 140, can help the users select a vacation appropriate for their mutual interests. In addition, any feedback received back from the users can help refine the matching algorithms not only for the specific users, but on a global basis.

An example assessment mechanism is to monitor the words used during the matched users on-line exchanges. One skilled in the art would recognize that this information can be analyzed by the explore module 30 to derive an affective or emotional profile which can serve as additional clues into the preferences and attributes of the user and candidate(s). Turning to step 480, the explore module 30 interfaces with the match engine 150 to adjust the parameters used by the match engine 150 in generating matches for the user. Some of the techniques used to adjust the match engine 150 parameters have been discussed above. These techniques generally include adjusting match engine parameters on the guidance of observations of user behavior and feedback received by the user. For example, questions, concerns and goals raised by the user as part of enhance module 144 programs, observations made during connectivity sessions via the connect module 154, various features highlighting common themes accessed by the user via the features module 138 and various products and services accessed by the user via the e-commerce module 140 can establish information assimilated by the explore module 30 in assisting the user to select various criteria to search for compatible individuals for the user. Another technique addressed above is opening the search algorithms to physical and/or personality categories which have not been identified as direct compatibilities, but are close in nature, such as persons falling in the “gray zone” attraction categories.

As indicated above, the explore module 30 will attempt to assist the user in making choices when stated desires and implicit goals conflict with one another to control specific criteria on which the search engine 150 will operate. More specifically, as part of the personality module 148 the user specifies the types of persons the user feels they will be most compatible with and the personality module 148 requests feedback on what qualities may attract the user instinctually. Since these profiles do not have complete overlap, the explore module 30 is designed to make the user aware of any significant contradictions and help the user determine how the match engine 150 should address these differences during the match engine's search for compatible individuals.

As an example, consider a female user whose personality profile assessment indicates that she is very introverted and moderately active but is instinctually drawn to highly extroverted and very active men. Research in the field indicates that this user will have long term compatibility with moderately extroverted and active men. In this case, the explore module 30 will share this observation with the user and ask the user whether this fits her experience. The explore module 30 is also programmed to ask the user which course of action she would prefer such as 1) focus only on highly extroverted and very active men (i.e., her instinctual type); 2) focus on men of moderate or high extroversion and activity thereby allowing for matches with men in her true compatibility range to be considered; or 3) focus only on moderately extroverted and active men (thereby eliminating her instinctual type but pursue those who may be most compatible). In other words, the explore module 30 attempts to make the user more aware of what was previously beyond the user's own awareness and proceed with extensive control over what factors are considered by the match engine 150 and how they are considered. This allows the match engine 150 to consider unobservable attitudes and personality qualities of users when attempting to find compatible matches.

The explore module 30 also allows the user to control different types and levels of risk. Controlling the types and levels of risk, and therefore the match engine's possible outcomes, allows the user greater flexibility in screening in or out a wider variety of individuals. More specifically, the match engine 150 will always attempt to identify true positives and minimize the number of false positives and true negatives. However, depending on the user's preferences, the match engine 150 can expand the matches to include a greater or lesser number of false negatives. As more false negatives are targeted, the likelihood that false positives, and maybe even some true negatives, also increases. False positives are generally considered undesirable as they consume the user's time and may invoke negative emotions when the couple turns out not to be compatible with each other. However, if the user is tolerant of this risk and is wary of excluding people who might be compatible (i.e., false negatives) then the explore module 30 can assist the user in expanding the number of matches generated by the match engine 150. As an example, a user who is just starting to date may choose to date a wide variety of people in order to broaden her life experience and judge her most salient risk as missing a perfect match (e.g., a false negative). On the other hand, another user with less time to date and who has had several previous bad dating experiences, may be concerned with being matched with a false positive and tend to avoid that situation. Depending on the selections made by the user, the explore module 30 will relax or restrict multiple parameters concerning physical and personality attributes of potential matches in hope to optimize matches relating the user's risk level. One specific area targeted by the explore module 30 is to focus match criteria and parameters based on the short term or long term goals of the individuals (e.g., having fun on a few dates or seeking marriage in a short period of time).

Where only a small number of matches are identified in step 460, the explore module 30 will inform the user of various options for relaxing the search criteria in order to generate additional matches. For example, if the user had expressed a strong preference for women his same age or younger, the explore module 30 may suggest to the user that by relaxing the criteria to allow matches of women up to 3 years older the user would receive perhaps three times the number of potential matches to consider.

When potential matches are presented to the user, the user has the opportunity to view swap information selected by the individual. If the user seems interested in this individual but is unsure or has outstanding questions, the explore module 30 (via both user's SAM agent modules 130), can assist the users in assessing their compatibility. For example, the match engine 150 may generate a match result for a particular user who is fairly religious and concerned that the matched individual may not share the same level of religious affiliation. The user may then have the option of seeking out an answer to his concerns by asking the other user how often do you go to church each month, for example. Alternatively, before presenting this potential match to the user the match engine 150 may recognize that it does not have complete information in order to assess the compatibility of two particular users. Therefore, the match engine will prompt the explore module 30 and the respective SAM agents 130 to seek out the needed information from one or both of the users.

The software application 76 is provided with mechanisms for making positive and constructive interventions 54. An intervention attempts to invoke a change in the user's behavior. The software application 76 attempts to educate users on how to overcome intra and inter personal obstacles to connecting with others and attempts to structure interpersonal encounters in ways that are most likely to be rewarding and to facilitate relationship growth. As a foundation to this approach, the knowledge derived from extensive psychological and psychiatric literature on assisting people in overcoming intrapersonal or psychological difficulties to improve their interpersonal functioning is utilized. Derived from this research are at least nine contexts, or methods, to intervention. Associated with these contexts to intervention, there are at least eleven strategies in carrying out intervention. These contexts and strategies and how they are addressed by the software application 76 are described below.

Before addressing the various contexts and strategies, an overview of the intervention systems 54 provided by the software application 76 will be made. Components in the overall intervention framework include gathering insight into a user's attraction preferences, both physically and intra/inter personally. This information is mainly collected using the physical module 146 and the personality module 148. Other components include searching for potential relationship matches using user-independent algorithms that grow to become user-dependent algorithms based on user customization and experience, such as those techniques found in the explore module 30 and the match engine 150. A customizable and evolving SAM agent 130 which acts as a personal guide to all of the offerings of the software application 76 is an instrumental player in the intervention framework as the SAM agent 130 acts as a conduit for advice, reminders and referrals to the user. The coach module 50, in its role as a repository for a vast set of audio and text messages and/or cues to offer basic advice and guidance throughout every stage of the user's interaction with the software application 76, is also a component in the software application's intervention framework. Furthermore, the enhance module 144 offers performance enhancement programs which are in-depth, interactive leaming programs geared towards improving social and relationship functioning, plus overall emotion, spiritual and physical well-being. In addition, the connect module 154 provides opportunities for communication and shared experience with others seeking similar goals. In addition to standard email, instant messaging and chat room connections, the connect module 154 focuses on shared activities. Shared activities include, for example, opportunities to tour a web site such as an on-line museum or play interactive games while simultaneously having a conversation about the experience with another participant.

Information from the coach module 50 including advice and responses to user's questions or concerns is available at any time via the SAM agent 130 to help the user prepare for making connections, make early decisions regarding whether to follow up with an individual and how, advance to more developed stages in an interpersonal relationship, build a good foundation for a relationship, and optimize communication between the SAM agent 130 and user or the between the user and another individual. Therefore, the advice offered by the coach module 50 represents a basic level of intervention for those users who need encouragement or small amounts of adjustment in their communication style and/or skills. In contrast, the enhance programs available through the enhance module 144 are designed to offer more in-depth skill building for those users facing significant intra or interpersonal obstacles in forming lasting and meaningful relationships.

Research indicates there are various common success factors in carrying out intra and interpersonal interventions. These success factors are broken down into a number of context factors, or how to intervene with an individual. The factors are also broken down into strategies, or what to do, to carry out a successful intervention. Focusing on the context factors, a first context factor is identifying intra and interpersonal regularities by both observing the individual and gaining information through self-reporting by the individual. This information is used to identify modes of thinking and patterns of behavior and the negative or positive consequences of that behavior. The software application 76 utilizes the physical module 146 assessments and the personality module 148 assessments to derive a user's intrapersonal mode of thinking and behaving. In furtherance of this context factor, the SAM agent 130 asks the user for feedback and observes user behavior to gather information on regularities on an on-going basis. A primary focus of the questions asked by SAM agent 130 is the consequences of user behavior patterns, such as whether an experience was positive or negative for the user.

Another context factor is the user's readiness for change assessed by parameters such as the individual's stage of change (i.e., pre-contemplation, contemplation, preparation, action, maintenance, or relapse) or the individual's motivation in order to customize the type and level of the intervention. To address this context factor, both the coach module 50 and the enhance module 144 ask the user questions via the SAM agent 130 regarding their interest and readiness for information, advice, and skill training in order to tailor information and programs presented to the user as is appropriate for the user's stage of change or readiness for change.

The use of repeating assessments about the individual is another context factor important to establishing user interventions. More specifically, the target phenomenon is assessed using multiple methods and perspectives. Repeated measurement is encouraged to test the effectiveness of various intervention options. The user's self-monitoring of change is also encouraged to increase the user's level of self-awareness and knowledge of the natural change process. The software application 76 conducts repeat assessments by encouraging the users to repeat the physical and personality assessments, especially as the user tries out new attitudes and behaviors. In addition, the SAM agent 130 routinely asks the user to rate interpersonal contact with others in terms of valence and arousal, while tracking the salience of these reactions. Furthermore, the programs offered by the enhance module 144 integrate repeated assessments and self-monitoring as part of their core templates.

Another context factor is the individual's choice and control over the focus of an intervention and options, when appropriate, to control the scope and depth of the intervention. The software application 76 allows the user to control which modules or elements of the software application 76 that they wish to use. In addition, the coach module 50 and the enhance module 144 ask the user's permission before offering more in-depth feedback regarding the user's behavior or exploring additional intervention options.

Yet another context factor for successful interventions is pacing. Generally, gradual and self-controlled exploration is encouraged for most users. However, certain factors which control pace, such as rates, ranges and rhythms of learning, are highly individualized. Therefore, the intervention options should allow for dynamic shifts in intensity and direction of change as part of the intervention process. The software application 76 allows users to customize the pace of their enhanced module 144 programs.

Another context factor is referred to as leverage for dynamic change. Leveraging for dynamic change involves strategically targeting aspects of the individual's thinking and/or behavior that create an improved context within which other changes may occur, either spontaneously or as part of interlinked changes. For example, small steps can ultimately lead to significant shifts in behavior. The software application 76 uses a small steps approach where the coach module 50 presents encouragements to set the stage for potentially broader user change. In addition, the enhance module 144 presents programs which are strategically targeted to skill areas that would offer the best potential for overall user change.

Involving other persons in the user's intervention is also a context factor to be considered. If appropriate, it is generally beneficial to involve others in an intervention. These people could be family members or romantic partners. Involving these social ties in the intervention is encouraged to address problematic patterns and/or builds sources of on-going reinforcement and support for the user. Involving social ties is carried out by the software application 76 by encouraging romantic partner, or friend participation in enhance module 144 programs. In addition, the connect module 154 supplies opportunities for shared opportunities with new and existing social ties.

The last context factor is providing a safe and supportive environment for the individual undergoing an intervention. Learning and positive psychological development is facilitated by the presence of safe, stable and caring environments involving other persons who encourage the person to try out new behavior and modes of thinking. The software application 76 emphasizes privacy and confidentiality of the user's information. In addition, the SAM agent 130 has an interface design to represent a safe, stable and caring guide to the user's exploration through the functionality of the software application 76.

As indicated, there are a variety of strategies which have proven successful in carrying out intra and interpersonal interventions. One strategy is to build upon existing strengths. This strategy generally increases the frequency and regularity of modes of thinking, patterns of behavior, and activities that promote positive emotions and positive interpersonal experiences for the individual undergoing the intervention. The software application 76 provides for asking questions and offering encouragement via the coach module 50 in ways targeted to promote the user's strengths. The enhance module 144 encourages thinking and behavior that promotes positive emotions in interpersonal activities and works to expand these opportunities.

Another strategy is correcting faulty beliefs and expectations. Beliefs, expectations and modes of thinking that result in negative emotions and/or negative interpersonal experiences should be restructured. The software application 76 provides functionality in the physical module 116 to give the user an opportunity to examine their preferences and possible mismatches in their physical expectations of romantic partners. In general, the physical module 116 challenges societal conventions regarding a narrow definition of attractiveness. Similarly, the personality module 148 highlights differences between the user's stated preferences and implicit preferences. The coach module 50 has immediately available feedback to help the user examine and restructure their beliefs while the enhance module 144 provides programs for more in-depth correction of faulty beliefs and expectations. In fact, developing optimum cognitive patterns is a focus of all the programs proffered by the enhance module 144.

Another effective strategy is behavior rehearsal where the person undergoing intervention role plays and practices new behaviors in anticipated real-life situations. The software application 76 provides programs via the enhance module 144 which includes opportunities to role play and practice new behaviors on-line with the SAM agent 130 and other users. With the user's permission, the SAM agent 130 will also observe the user's interactions in chat rooms or other connectivity programs as these forums grant the user an opportunity to practice specific behaviors.

Another strategy is modeling, or having the individual observe new behaviors or modes of thinking as illustrated by instructors or peers. The software application 76, via the enhance module 144, provides programs which include video and audio vignettes which illustrate new behaviors and modes of thinking to the user. The vignettes are matched to the user to take advantage of demographic similarities between the user and the characters in the vignettes.

Another strategy is the use of feedback, reinforcement and shaping techniques. Shaping and gradual approximation directed towards obtaining the desired behavior is often beneficial. The intervention mechanism may explicitly create rewards for the user as certain goals are accomplished. The interference mechanism may also create opportunities for the social ties of the person undergoing the intervention to provide feedback at certain milestones and remind those social ties to provide the feedback as they may not notice the incremental improvements in behavior. The software application 76, via the coach module 50, praises users for progress towards their personal goals. The programs offered by the enhance module 144 are designed to reinforce the user's behavior and recognize improvements. If the user authorizes, the SAM agent 130 can seek out anonymous feedback from others who have had contact with the user (including matched individuals) in order to get their feedback and/or positive encouragement. These individuals may also provide negative comments to be recognized by the SAM agent 130 and addressed using the intervention vehicles described herein.

Yet another strategy is to give assignments to the user, thereby providing the user with an opportunity to practice new behaviors and explore novel intra and interpersonal possibilities on his or her own time schedule. The software application 76, through the coach module 50 and the enhance module 144, includes suggested activities, both on-line and off-line for the users to practice and expand their skills.

Another strategy is to facilitate the individual's exposure to normally avoided sources of anxiety for that person. Using multiple methods, such as reciprocal inhibition, counter conditioning and emotive and insight oriented approaches, an individual's exposure can be gradually increased in a manner which includes relaxation of the distress which normally causes anxiety or avoidance of the situation. The software application 76 provides programs via the enhance module 144 to offer an on-line, interactive way to gradually expose a user to normally avoided social and relationship situations and issues.

Yet another technique is to offer opportunities for role reversal. This involves giving the individual a chance to experience what it is like to interact with him or herself and view their life situations from a different vantage point. The software application 76 provides programs via the enhanced module 144 which include the capacity for the SAM agent 130 to observe and then mimic the individual's interpersonal style. Encouraging role taking and role reversal simulations is also a theme presented by the coach module 50 and the enhance module 144.

Another strategy is to change real and perceived behavioral contingencies. For example, an intervention technique is to help plan an individual's daily activities to reduce the likelihood of negative experiences and increase the likelihood of rewarding experiences. In order to achieve a desired goal, the individual's expectations, both conscious and unconscious, are altered. The software application 76, via the coach module 50 and the enhance module 144 specifically ask the user about perceived contingencies surrounding certain social and relationship situations. The responses given will enable these modules to address the user's perceived contingencies and offer enhance programs to alter the user's real and perceived contingencies in a systematic way.

Another strategy is to offer advice. Although self-initiated action is generally preferred, when certain courses of action are likely to have a fairly predictable positive consequence, it is acceptable to share these courses of action as options for the individual to consider. In the software application 76, the coach module 50 and the enhance module 144 offer explicit advice in areas where adaptive and maladaptive ways of thinking and behaving have been clearly identified.

A strategy which anticipates environmental resistance can be successful in carrying out intra and interpersonal interventions. More specifically, the intervention should anticipate and address ways that the person's social ties and life context will hinder rather than foster change. As a consequence, the intervention can promote external support and reinforcement for new behaviors. In the software application 76, the programs offered by the enhance module 144 help users anticipate ways that their social ties may support and/or undermine new behaviors. If necessary, the programs will assist the user to change these contingencies where necessary.

Although discussion of the enhance module 144 has focused on explicit instruction, there are potential implicit elements as well. Ongoing monitoring of improvement can involve implicit measures of the focus trait, such as “shyness,” as described for the Persona module 148, rather than relying on explicit self-reports. Similar technology can also be used as a means of linking certain mental associations targeted by the intervention. For example, an image relevant to the issue (e.g., a photograph of a party, representing extroversion) could be presented explicitly, while adjectives associated with positive associations (e.g., fun, exciting, interesting, friends) can be presented subliminally intermittently surrounding the photograph's presentation. While a shy user may initially associated negative words (e.g., loud, scary, threatening, crowded) with a party, effective intervention to associate more positive associations with parties should ultimately improve positive reactions on explicit and implicit measures of reactions to parties. Obviously, the use of any implicit intervention that by design reduces conscious awareness and control, though to only a small degree, still requires explicit informed consent by the user.

A module referred to as the preparation application/module is designed to prepare and facilitate connections between a user and candidates he or she has chosen to pursue. Specifically, the application is designed to optimize positive expectations prior to an in-person meeting, provide topics of conversation to facilitate sharing of information, increase the likelihood of connection, and enhance or prime a sense of liking, familiarity, and trust between the parties. To this end, the application shares information on the two parties' commonalities and delivers it using psychological priming methods that enhance the emotional and cognitive impact of the brief preparation.

This approach starts by extracting information about the fit between the user and candidate that is generated in search process. Specifically, the system identifies dimensions where there is a fit between one person's preference and the other's attribute. This could include fits between a personality style the user prefers and a personality attribute of a candidate. An expansion of the search logic could look for matches between the two in common experiences, education, interests, and activities.

The preparation application constructs a brief introduction media segment for each of the parties to view prior to their meeting. The brief segment is compiled guided by expert logic that gives priority to presenting information on their common likes, characteristics, and experiences. One skilled in the art will recognize that research offers guidance to the designer in order to offer higher priority and emphasis on certain topics most likely to have the impact desired. Segments are constructed pulling from both media elements the user supplies to the system to represent them (e.g., personal photos, movie clips, music clips) and a database library of images specifically identified to represent certain topics and areas of commonalities.

The presentation of the images and other segment media is structured to optimize psychological priming. Priming is the activation of cognitive and affective schemas or structures in the brain. The application allows the user to give permission or deny the use of the priming techniques. When applied, the system is designed to present words and images in a particular manner with specific timing in order to optimize recall and activate certain desired emotional and attitudinal connections. One skilled in the art will recognize that presenting certain emotion words and emotional images at a speed that cannot be recognized consciously, while simultaneously presenting the commonality images and information, can set the stage for more positive associations with the information and with the person he or she is going to meet. The feedback system outlined earlier can be used after the first meetings to assess whether the desired outcomes of liking, familiarity, and trust occurred. Subsequently, across observations such information can lead to improvements in the images used and in the priming presentation methodology.

Although particular embodiments of the invention have been described in detail, it is understood that the invention is not limited correspondingly in scope, but includes all changes, modifications and equivalents that fall within the spirit and terms of the claims appended hereto.

What is claimed is:

1. A method of profiling, matching and optimizing performance of large networks of individuals, comprising obtaining information of a user's preferences relative to a target, synthesizing the information into conclusions, estimating the fit between the user's preferences and a potential target's attributes, predicting an outcome of an encounter between a user and a target, observing the outcome between the user and the target and obtaining feedback from the user and the target after the occurrence of the encounter.

2. The method of claim 1, further comprising obtaining input from one or more targets prior to the encounter between the user and said one or more targets.

3. The method of claim 1, further comprising classifying the user and target on the basis of the estimated fit quality between the user's preferences and the target's attributes.

4. The method of claim 1, wherein the information of a user's preferences is obtained by one more modules involved in direct assessment, oblique assessment and input, wherein said input is obtained from peers or external judges.

5. A method of matching large networks of individuals with one or more targets, comprising matching a user with a first set of potentially compatible targets based on mutually corresponding preferences, the first set being generated with a set of user-independent search criteria, modifying the user-independent search criteria with feedback from the user and criteria established by the user, and generating subsequent sets of potentially compatible targets based on the modified criteria.

6. The method of claim 5, further excluding a target from the sets of potentially compatible targets when the target has at least one characteristic inconsistent with a deal breaker criteria established by the user.

7. The method of claim 5, further comprising obtaining additional information from the user or a target when the information to ascertain a match between the user and the target is incomplete.

8. The method of claim 5, wherein the user established feedback and criteria includes an assessment of the user's preference to specific target characteristics.

9. The method of claim 5, further comprising linking the user to a matched target.

10. The method of claim 5, wherein the step of matching the user with potentially compatible targets is further based on mutually corresponding persona preferences, the user's persona preferences measured along stated dimensions and along implicit dimensions.

11. A system for profiling, matching and optimizing performance of large networks of individuals, comprising a server having a processor for executing a software application and for exchanging data related to the software application with a user over a network medium, wherein the software application contains logic to assess the preferences of the user along explicit and implicit dimensions and to match the user with potentially compatible targets based on the user's preferences.

12. The system of claim 11, wherein the software application contains logic to categorize the user with individuals having similar preferences for one or more targets.

13. The system of claim 11, wherein the software application contains logic to reassess the user's preferences based on feedback received from the user.

14. The system of claim 11, wherein the software application contains logic to estimate the fit between the user's preferences and a potential target's attributes.

15. The system of claim 11, wherein the software application contains logic to predict an outcome of an encounter between a user and a target.

16. The system of claim 11, wherein the software application contains logic to observing the outcome between the user and the target.

17. A method for matching a user to a target, said method comprising the steps of:
accessing a guide that serves as an agent for facilitating the search and match process and customizing related information;
allowing a user to personalize the guide's personality, image, representation, voice and other features;
performing tests that directly assess the user's preferences and attributes or the object's attributes via self-report clues and counter clues;
performing tests that indirectly or obliquely assess the user's or the object's preferences and attributes via implicit methods;
obtaining feedback from a target group regarding the user's preferences and attributes or the object's attributes;
tagging the attributes of a user or an object via a semi-automated system involving human expert judgment;
reporting the presented conclusions on the preferences and attributes of the user and the object in order to promote education and gain further feedback;
aggregating multiples clues and synthesizing the clues, while estimating the parameters and confidence levels in light of missing, inexact and contradictory information;
customizing the presentation of information, education and advertising and facilitating commerce based on a user's or object's preferences and attributes;
estimating the fit quality between the user's preferences and attributes and the preferences and attributes of a pool of potential candidates and objects;
providing the user control over the domain to be searched and the level of tolerance for false positives and false negatives;
clustering heterogeneous groups of users and objects into homogeneous subgroups based on similarities in preferences and attributes;
classifying the object on the basis of the user's satisfaction with the object;
searching and ranking a pool of objects based on the estimated fit quality with the user's preferences and attributes;
predicting an outcome following one or more encounters between the user and the object;
optimizing the quality of the search and match process based on adjustment to the search and match parameters to narrow the gap between predicted and observed behavior;
observing the user's behavior to assess the gap between predicted user and observed user actions and reactions
obtaining feedback from the user and the object following at least one encounter between the user and the object;
offering advice to the user that is tailored to the user's assessed goals and readiness for change;
preparing the information between the user and the object prior to any encounter between the user and the candidate;
preparing a user for an encounter with a target by sharing information on the target regarding areas of mutual compatibility while simultaneously priming expectations, trust and familiarity through the implicit use of custom images and words;
synthesizing and presenting feedback received from potential targets to the user in a manner that fosters readiness for change;
providing intervention to facilitate desired changes in the preferences and attributes of the user or the object; and
testing the impact and effectiveness of words and images through an automated system that randomly pulls and systematically evaluates the stimuli from a large pool of media.

18. A system for matching a user to a target comprising a server having a processor for executing a software application, wherein the user is guided by a customized and personalized agent in the execution of the software application in the areas of data collection, data presentation, or self-improvement.

19. The method of claim 1 wherein information of the user's preferences relative to a target is obtained by a combination of one or more processes including direct assessment, indirect assessment, feedback from a target group and tagging the user's preferences and attributes via a coding process.

20. The method of claim 17 wherein estimation of the fit quality between the user and the object is based upon previously derived encounters between comparable users and objects or statistical modeling of scenarios that compare a single search result to the percentiles of all projected fit results.
